(19) United States
(12) Patent Application Publication
(10) Pub. No.: US 2018/0068272 A1
(43) Pub. Date: Mar. 8, 2018

(54) SCHEDULE EDITING METHOD AND SCHEDULE EDITING DEVICE

(71) Applicant: FUJITSU LIMITED, Kawasaki-shi (JP)

(72) Inventor: TAKUMA OKUDA, Kawasaki (JP)

(73) Assignee: FUJITSU LIMITED, Kawasaki-shi (JP)

(21) Appl. No.: 15/682,707

(22) Filed: Aug. 22, 2017

(30) Foreign Application Priority Data
Sep. 7, 2016 (JP) 2016-175060

(51) Int. Cl. G06Q 10/10

(52) U.S. Cl. CPC G06Q 10/109

(57) ABSTRACT

A non-transitory computer-readable recording medium stores therein a program that causes a computer to execute a process. The process includes receiving registration of a schedule of one or a plurality of tasks; and referring to a storage unit in which a predetermined event is stored in association with both a time zone that is allowed as allocation destination and duration and registering, in the schedule when the duration can be secured in the time zone and in a time zone other than the time zone associated with the registered one or the plurality of the tasks, the one or the plurality of the tasks and the predetermined event.

### CROSS-REFERENCE TO RELATED APPLICATION

This application is based upon and claims the benefit of priority of the prior Japanese Patent Application No. 2016-175060, filed on Sep. 7, 2016, the entire contents of which are incorporated herein by reference.

### FIELD

The embodiments discussed herein are related to a schedule editing method and a schedule editing device.

### BACKGROUND

Conventionally, schedule management software that manages schedules is used. With this schedule management software, for example, various kinds of tasks, such as a task of preparing for a customer visit, a task of visiting a customer, a task of planning to make a phone call to a customer, or the like, are registered together with planned date and time.

Patent Document 1: Japanese Laid-open Patent Publication No. 2012-248072

With conventional schedule management software, although important tasks, such as tasks related to customers or the like, are registered, in some cases, tasks of optional predetermined events, such as tasks related to workers themselves, or the like, are not registered. For example, an insurance salesperson registers and manages tasks, such as a task of preparing for a customer visit, a task of visiting a customer, a task of planning to make a phone call to a customer, or the like; however, the insurance salesperson sometimes does not register lunch or a move to the visit destination as a task. Consequently, it is sometimes unclear whether the registered task can be performed. Here, a schedule of an insurance salesperson has been described as an example; however, this problem generally occurs when registration of a task of a predetermined event is omitted.

### SUMMARY

According to an aspect of an embodiment, a non-transitory computer-readable recording medium stores therein a program that causes a computer to execute a process. The process includes receiving registration of a schedule of one or a plurality of tasks; and referring to a storage unit in which a predetermined event is stored in association with both a time zone that is allowed as allocation destination and duration and registering, in the schedule when the duration can be secured in the time zone and in a time zone other than the time zone associated with the registered one or the plurality of the tasks, the one or the plurality of the tasks and the predetermined event.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating, in outline, the configuration of a schedule system according to a first embodiment;

FIG. 2 is a block diagram illustrating an example of the configuration of a server device;

FIG. 3 is a schematic diagram illustrating an example of the data structure of user information;

FIG. 4 is a schematic diagram illustrating an example of the data structure of customer information;

FIG. 5 is a schematic diagram illustrating an example of the data structure of phone contact information;

FIG. 6 is a schematic diagram illustrating an example of the data structure of menu information;

FIG. 7 is a schematic diagram illustrating an example of the data structure of main schedule information;

FIG. 8 is a schematic diagram illustrating an example of the data structure of sub schedule information;

FIG. 9 is a schematic diagram illustrating an example of the data structure of task information;

FIG. 10 is a schematic diagram illustrating an example of the data structure of comparison achievement information;

FIG. 11 is a schematic diagram illustrating an example of the data structure of automatic additional task information;

FIG. 12 is a schematic diagram illustrating an example of the data structure of move information;

FIG. 13A is a schematic diagram illustrating an example of a schedule screen;

FIG. 13B is a schematic diagram illustrating an example of the schedule screen;

FIG. 13C is a schematic diagram illustrating an example of the schedule screen;

FIG. 13D is a schematic diagram illustrating an example of the schedule screen;

FIG. 13E is a schematic diagram illustrating an example of the schedule screen;

FIG. 13F is a schematic diagram illustrating an example of the schedule screen;

FIG. 14A is a schematic diagram illustrating an example of a display of a target value and an achievement values of a task;

FIG. 14B is a schematic diagram illustrating an example of a display of a need value of the task;

FIG. 14C is a schematic diagram illustrating an example of displaying whether an undisplayed task is present;

FIG. 14D is a schematic diagram illustrating an example of a display of subtasks;

FIG. 14E is a schematic diagram illustrating an example of a display of the subtasks;

FIG. 14F is a schematic diagram illustrating an example of the schedule screen;

FIG. 15 is a schematic diagram illustrating an example of the data structure on the main schedule information in which tasks are automatically added;

FIG. 16A is a schematic diagram illustrating an example of the schedule screen;

FIG. 16B is a schematic diagram illustrating an example of the schedule screen;

FIG. 16C is a schematic diagram illustrating an example of the schedule screen;

FIG. 16D is a schematic diagram illustrating an example of the schedule screen;

FIG. 16E is a schematic diagram illustrating an example of the schedule screen;

FIG. 16F is a schematic diagram illustrating an example of the schedule screen;

FIG. 17A is a flowchart illustrating the flow of a task registration process;

FIG. 17B is a flowchart illustrating the flow of a schedule display process;

FIG. 17C is a flowchart illustrating the flow of an automatic registration process; and

FIG. 18 is a block diagram illustrating a computer that executes a schedule editing program.

### DESCRIPTION OF EMBODIMENTS

Preferred embodiments of the present invention will be explained with reference to accompanying drawings. Furthermore, the present invention is not limited to the embodiments. Furthermore, each of the embodiments can be used in any appropriate combination as long as the processes do not conflict with each other.

### [a] First Embodiment

System Configuration

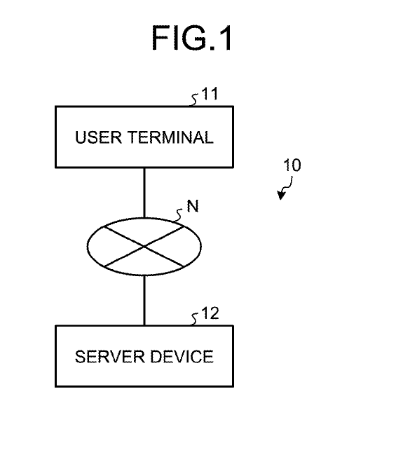

First, an example of a schedule system 10 according to a first embodiment will be described. FIG. 1 is a schematic diagram illustrating, in outline, the configuration of the schedule system according to a first embodiment. As illustrated in FIG. 1, the schedule system 10 includes a user terminal 11 and a server device 12. In the embodiment, the server device 12 corresponds to a schedule editing device.

The schedule system 10 is a system that manages a schedule of a user. In the embodiment, a description will be given of a case of, as an example, managing a schedule of an insurance salesperson as a user. The insurance salesperson visits a customer, engages in business of insurance and, sells the insurance. Furthermore, in an office of an insurance company, the insurance salesperson conducts various kinds of preparation works in order to engage in business of insurance and sell the insurance. The user terminal 11 is connected to the server device 12 via a network N in a manner the devices can communicate with each other. Any kind of communication network, such as a local area network (LAN), a virtual private network (VPN), a mobile telecommunications network, or the like, may be used as the network N irrespective of whether the network is a wired or wireless connection.

The user terminal 11 is a device that is owned by an insurance salesperson who is a user. For example, the user terminal 11 is a mobile terminal device, such as a smartphone, a tablet terminal, or the like. The insurance salesperson accesses the server device 12 by using the user terminal 11, registers a plan of action or the achievements, and manages the schedule.

The server device 12 is a computer that provides a user with a schedule service that manages the schedule. The schedule service may also be provided by a single computer or may also be provided by a computer system constituted by a plurality of computers. Furthermore, in the embodiment, a description will be given of a case, as an example, in which the schedule service is provided by the single server device 12.

Server Device

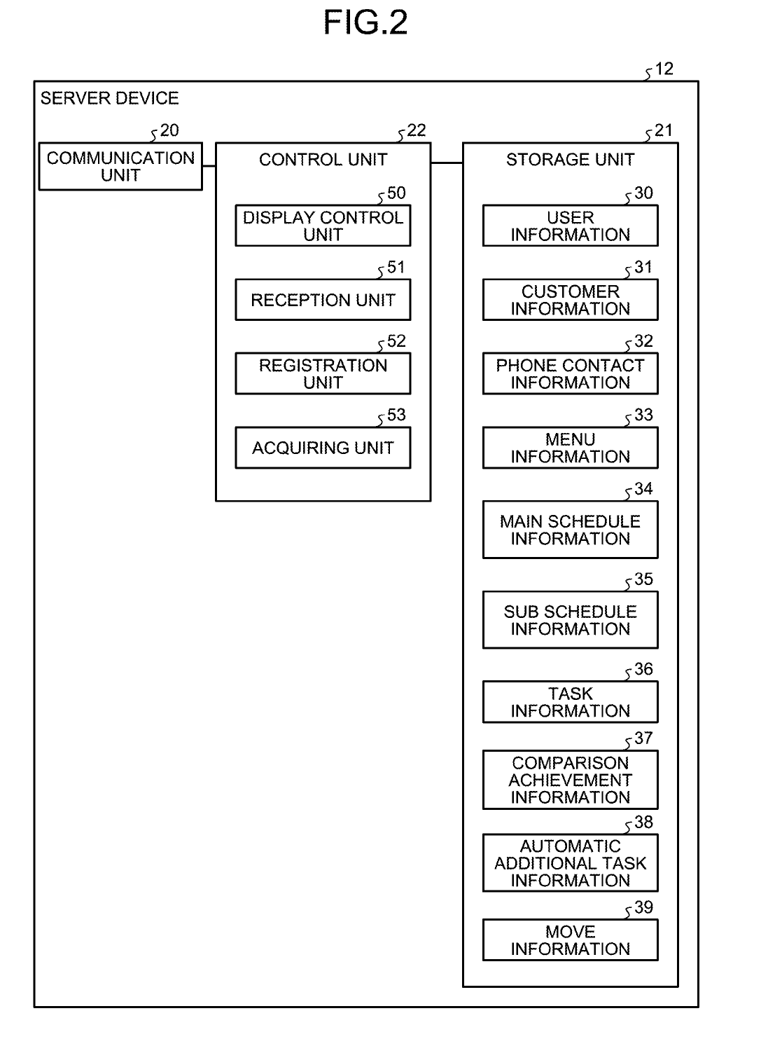

In the following, the configuration of the server device 12 according to the first embodiment will be described. FIG. 2 is a block diagram illustrating an example of the configuration of the server device. As illustrated in FIG. 2, the server device 12 includes a communication unit 20, a storage unit 21, and a control unit 22.

The communication unit 20 is an interface for performing communication control with other devices. The communication unit 20 sends and receives various kinds of information to and from the other devices via the network N. A network interface card, such as a LAN card, or the like can be used as the communication unit 20.

The storage unit 21 is a storage device, such as a hard disk, a solid state drive (SSD), an optical disk, or the like. Furthermore, the storage unit 21 may also be a semiconductor memory, such as a random access memory (RAM), a flash memory, a non-volatile static random access memory (NVSRAM), or the like, that can rewrite data. Furthermore, the storage unit 21 may also be an external server that stores therein data and that provides the data.

The storage unit 21 stores therein various kinds of programs. Furthermore, the storage unit 21 stores therein various kinds of data used by the various kinds of programs. For example, the storage unit 21 stores therein user information 30, customer information 31, phone contact information 32, menu information 33, main schedule information 34, sub schedule information 35, task information 36, comparison achievement information 37, automatic additional task information 38, and move information 39.

The user information 30 is the data that stores therein information related to a user who performs schedule management. In the embodiment, the user information 30 stores therein the information related to an insurance salesperson as a user who performs the schedule management.

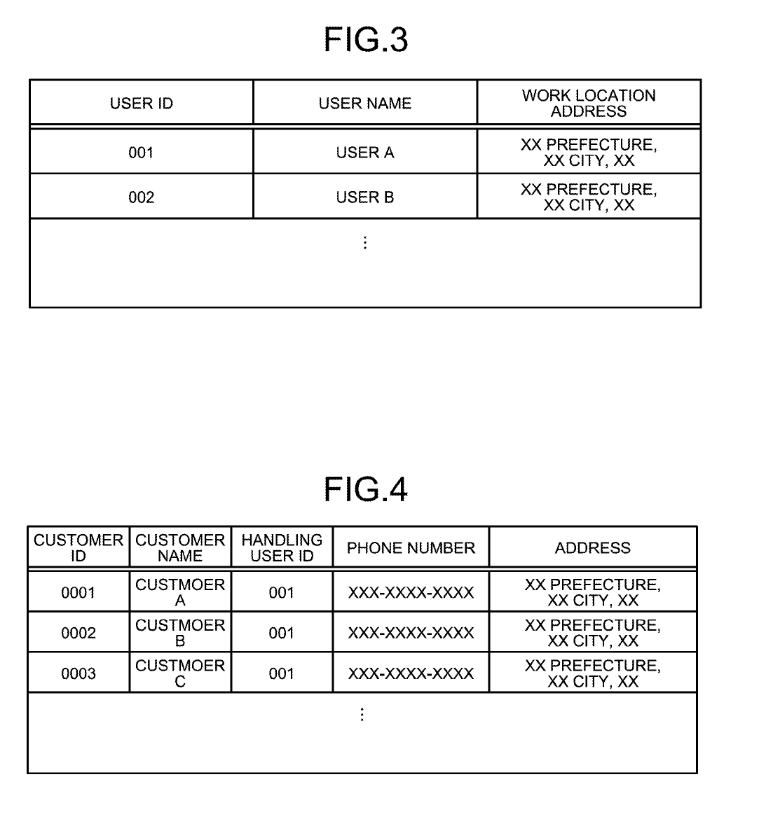

FIG. 3 is a schematic diagram illustrating an example of the data structure of the user information. As illustrated in FIG. 3, the user information 30 includes items, such as the “user ID”, the “user name”, the “work location address”, and the like. Furthermore, each of the items included in the user information 30 illustrated in FIG. 3 is an example and another item may also be included.

The item of the user ID is an area that stores therein identification information that identifies the insurance salesperson. A unique user identification (ID) is attached as the identification information to the insurance salesperson. In the item of the user ID, the user ID attached to the insurance salesperson is stored. The item of the user name is an area that stores therein the name of the user. The item of the work location address is an area that stores therein the address of the place of work for the insurance salesperson doing the work. For example, the example illustrated in FIG. 3 indicates that the insurance salesperson with the user name of “user A” has the user ID of “001” and indicates that the work location address is “XX prefecture, XX city, XX”.

The customer information 31 is the data that stores therein information related to customers. In the embodiment, the customer information 31 stores therein the information related to the customer to whom the insurance salesperson sold insurance policies and related to the customer to whom the insurance salesperson is doing business.

FIG. 4 is a schematic diagram illustrating an example of the data structure of customer information. As illustrated in FIG. 4, the customer information 31 includes items, such as the “customer ID”, the “customer name”, the “handling user ID”, the “phone number”, the “address”, and the like. Furthermore, each of the items included in the customer information 31 illustrated in FIG. 4 is an example and another item may also be included.

The item of the customer ID is an area that stores therein identification information that identifies a customer. A unique customer ID is attached as the identification information to the customer. In the item of the customer ID, the customer ID attached to the customer is stored. The item of the customer name is an area that stores therein the name of the customer. The item of the handling user ID is an area that stores therein the user ID of the insurance salesperson who handles the customer. The item of the phone number is an area that stores therein the phone number of the customer. The item of the address is an area that stores therein the address of the customer. For example, the example illustrated in FIG. 4 indicates that the customer with the customer name of “customer A” has the customer ID of “0001”, indicates that the user ID of the handling insurance salesperson is “001”, indicates that the phone number is “XXX-XXXX-XXXX”, and indicates that the address is “XX prefecture, XX city, XX”.

The phone contact information 32 is the data that stores therein information related to customers. In the embodiment, the phone contact information 32 stores therein the information related to the customers targeted by the insurance salesperson for a phone contact. The insurance salesperson receives a notification from a company indicating a customer targeted for a phone contact, such as a customer whose insurance is close to the due date or the like. For example, the phone contact information 32 is created by a system in an insurance company extracting the customers targeted by each of the insurance salespersons for a phone contact and is stored in the storage unit 21.

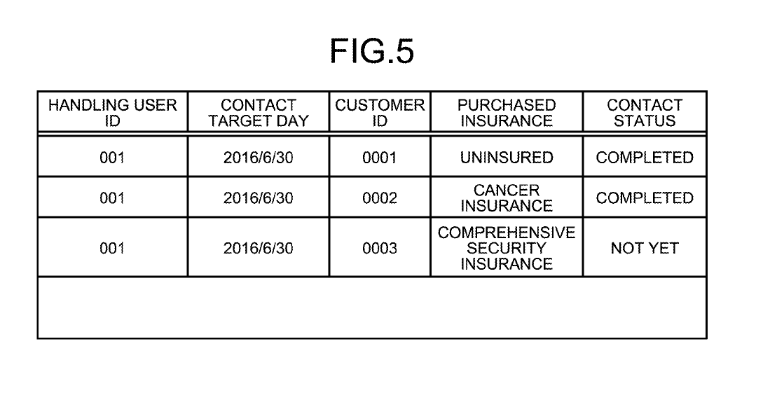

FIG. 5 is a schematic diagram illustrating an example of the data structure of the phone contact information. As illustrated in FIG. 5, the phone contact information 32 includes items, such as the “handling user ID”, the “contact target day”, the “customer ID”, the “purchased insurance”, the “contact status”, and the like. Furthermore, each of the items included in the phone contact information 32 illustrated in FIG. 5 is an example and another item may also be included.

The item of the handling user ID is an area that stores therein the user ID of the insurance salesperson who handles a phone contact. The item of the contact target day is an area that stores therein the target date in which a phone contact is performed on a customer. The item of the customer ID is an area that stores therein the customer ID of the customer targeted for the contact. The item of the purchased insurance is an area that stores therein an insurance purchased by the customer. The item of the contact status is an area that stores therein the status of the phone contact. For example, the example illustrated in FIG. 5 indicates that, regarding the insurance salesperson with the handling user ID of “001”, the customers with the customer ID of “0001”, “0002”, and “0003” are the customers targeted for the phone contact on Jun. 30, 2016. Furthermore, the example illustrated in FIG. 5 indicates that the customer with the customer ID of “0001” is uninsured and indicates that the phone contact has been completed.

The menu information 33 is the data that stores therein information related to the menu displayed when a schedule is registered. In the embodiment, the menu information 33 stores therein, as tasks, various kinds of actions, such as a preparation for visiting a customer, a visit to a customer, a plan to make a phone call to the customer, or the like, that is performed by the insurance salesperson who can register the actions in the schedule.

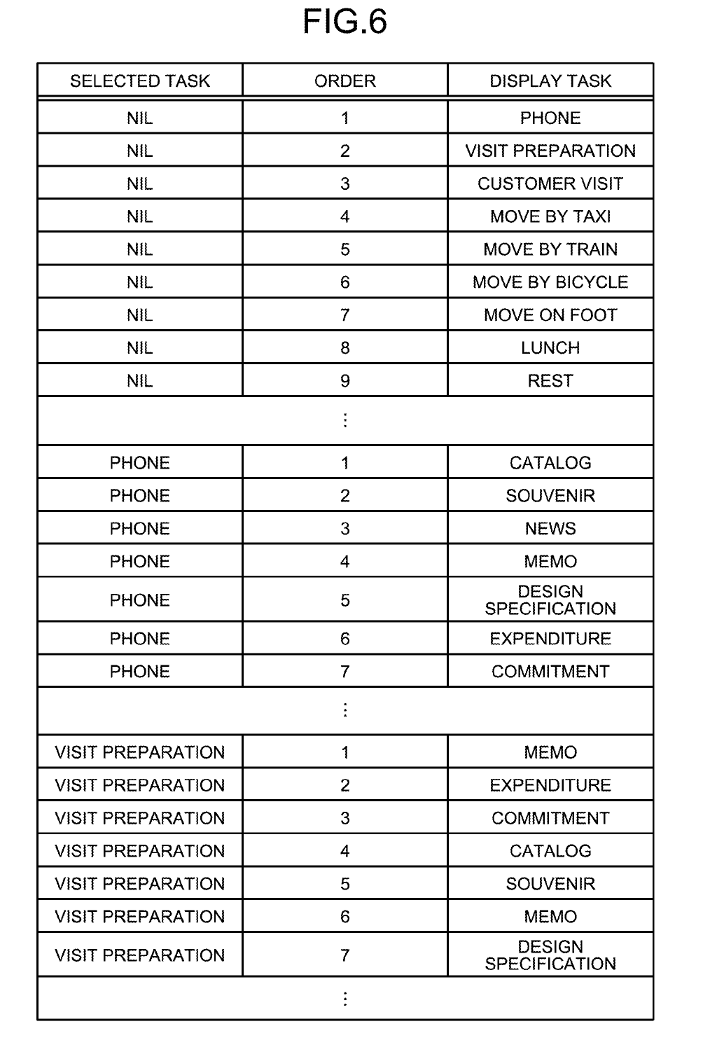

FIG. 6 is a schematic diagram illustrating an example of the data structure of the menu information. As illustrated in FIG. 6, the menu information 33 includes items, such as the “selected task”, the “order”, the “display task”, and the like. Furthermore, each of the items included in the menu information 33 illustrated in FIG. 6 is an example and another item may also be included.

The item of the selected task is an area that stores therein the tasks selected when the schedule has been registered. The item of the order is an area that stores therein the order of the tasks that are displayed on the menu. The item of the display task is an area that stores therein the tasks to be displayed on the menu. Here, in the embodiment, when the schedule is registered, the task to be displayed on the menu next time is changed in accordance with the task that has been selected on the menu. In the menu information 33, the tasks to be displayed on the menu are registered such that the task that is frequently accompanied by the selected task is displayed on the menu in accordance with the task selected on the menu. For example, in the menu information 33, the task, which is to be displayed on the menu if the task has not been selected in a case of registering the schedule, is registered as “nil” in the item of the selected task. Furthermore, in the menu information 33, the task, which is to be displayed on the menu if the task has not been selected in a case of registering the schedule, is registered as the task that has been selected in the item of the selected task. For example, in the example illustrated in FIG. 6, if the task has not been selected when the schedule is registered, each of the tasks of the “phone”, the “visit preparation”, and . . . is stored as the tasks to be displayed on the menu. Furthermore, in the example illustrated in FIG. 6, if the “phone” is selected when the schedule is registered, each of the tasks of the “catalog”, the “souvenir”, and . . . is stored as the tasks to be displayed on the menu.

The main schedule information 34 and the sub schedule information 35 are the data that stores therein information related to the task registered in a schedule. Here, regarding the task registered in a schedule by the insurance salesperson, there may be an accompanying task associated with the subject task. In the embodiment, the task that serves as the subject of the corresponding time in the schedule is managed as the main task, whereas the task that is allowed to be accompanied by being associated with the main task is managed as a subtask. The main schedule information 34 stores therein the information related to the main tasks registered in the schedule. The sub schedule information 35 stores therein the information related to the subtasks registered in the schedule.

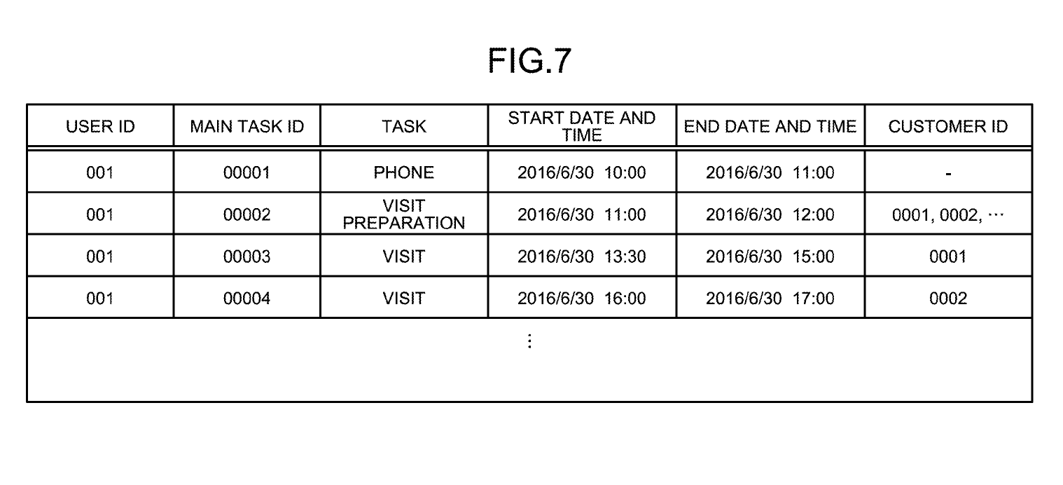

FIG. 7 is a schematic diagram illustrating an example of the data structure of the main schedule information. As illustrated in FIG. 7, the main schedule information 34 includes items, such as the “user ID”, the “main task ID”, “task”, the “start date and time”, the “end date and time”, the “customer ID”, and the like. Furthermore, each of the items included in the main schedule information 34 illustrated in FIG. 7 is an example and another item may also be included.

The item of the user ID is an area that stores therein the user ID of the insurance salesperson who has registered the tasks. The item of the main task ID is an area that stores therein the identification information that identifies the task that serves as the subject registered in the schedule. If the insurance salesperson registers a task in the schedule, a unique task ID is attached to the registered task as the identification information that identifies the registered task. In the item of the main task ID, the task ID of the task that serves as the subject registered in the schedule is stored. The item of the task is an area that stores therein the type of task that serves as the subject task registered in the schedule. The item of the start date and time is an area that stores therein the start date and time of the task that serves as the subject registered in the schedule. The item of the end date and time is an area that stores therein the end date and time of the task that serves as the subject task registered in the schedule. The item of the customer ID is an area that stores therein the customer ID of the customer targeted for the task that serves as the subject task registered in the schedule. In the item of the customer ID, if the task serving as the subject task registered in the schedule is the work to be performed on a specific customer, the customer ID of the specific customer is stored, whereas, if the task serving as the subject task registered in the schedule is the work that is not to be performed on the specific customer, “-” is stored. For example, the example illustrated in FIG. 7 indicates that, regarding the insurance salesperson with the user ID of “001”, the task of the “phone” with the task ID of “00001” is registered in the schedule between 10:00 and 11:00 on Jun. 30, 2016. Furthermore, because the item of the customer ID is “-”, the example illustrated in FIG. 7 indicates that the task of the “phone” is not the work performed on the specific customer.

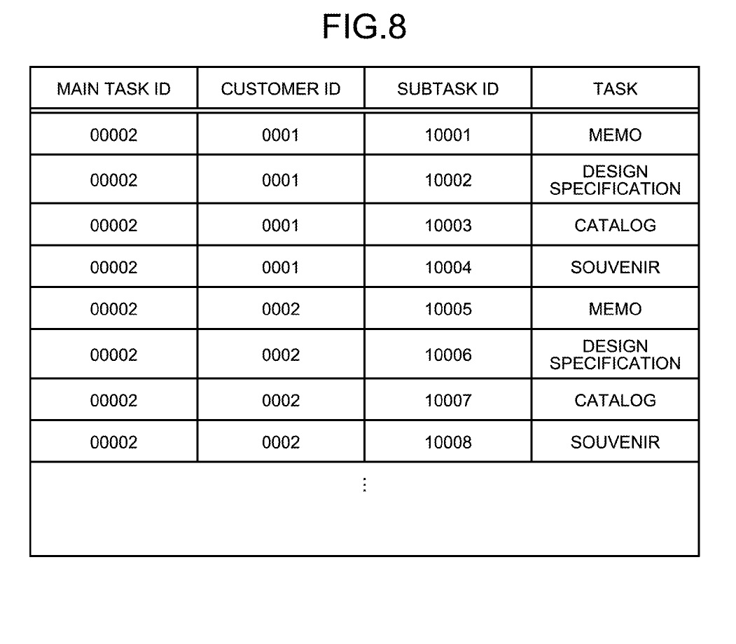

FIG. 8 is a schematic diagram illustrating an example of the data structure of the sub schedule information. As illustrated in FIG. 8, the sub schedule information 35 includes items, such as the “main task ID”, the “customer ID”, the “subtask ID”, the “task”, and the like. Furthermore, each of the items included in the sub schedule information 35 illustrated in FIG. 8 is an example and another item may also be included.

The item of the main task ID is an area that stores therein the task ID of the main task in which a subtask is associated. The item of the customer ID is an area that stores therein the customer ID of the customer targeted for the subtask. In the item of the customer ID, if the subtask is the work to be performed on a specific customer, the customer ID of the specific customer is stored, whereas, if the subtask is not the work to be performed on a specific customer, “-” is stored. The item of the subtask ID is an area that stores therein the task ID of the subtask that is registered by being associated with the main task. The item of the task is an area that stores therein the type of subtasks registered by being associated with the main task. For example, the example illustrated in FIG. 8 indicates that, regarding the main task with the task ID of “00002”, the task of “memo” to be performed by the task ID of “10001” is registered in the schedule.

The task information 36 is the data that stores therein information related to the task registered in the schedule. In the embodiment, the task information 36 stores therein information related to the main tasks and the subtasks registered in the schedule.

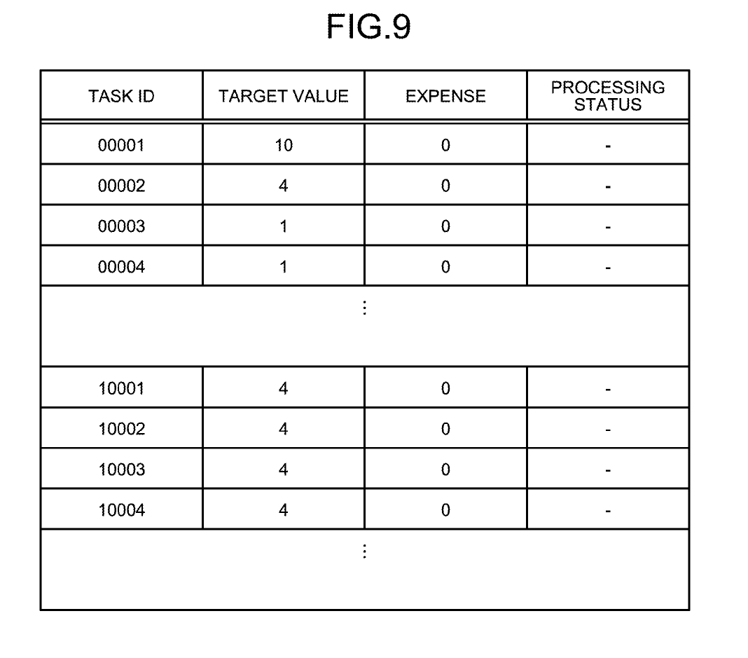

FIG. 9 is a schematic diagram illustrating an example of the data structure of the task information. As illustrated in FIG. 9, the task information 36 includes items, such as the “task ID”, the “target value”, the “expense”, the “processing status”, and the like. Furthermore, each of the items included in the task information 36 illustrated in FIG. 9 is an example and another item may also be included.

The item of the task ID is an area that stores therein the task IDs of the main tasks and the subtasks registered in the schedule. The item of the target value is an area that stores therein the target number of cases that are to be processed by the insurance salesperson in the registered main tasks and the subtasks. The target number of cases may also be determined for each of the types of tasks or may also be registered by the insurance salesperson. In the item of the target value, the target number of cases is stored. The item of the expense is an area that stores therein the expense incurred in the registered main tasks and the subtasks. The item of the processing status is an area that stores therein the processing status of the registered main tasks and the subtasks. In the item of the processing status, if the work of the task is unprocessed, “-” is stored, whereas, if the work of the task has been completed, “completed” is stored. For example, the example illustrated in FIG. 9 indicates that, regarding the task with the task ID of “00001”, the target number of cases is “10”, the incurred expense is “0” yen, and the work is unprocessed.

The comparison achievement information 37 is the data that stores therein the information related to the achievements used by each of the tasks as the comparison target. In the embodiment, if an insurance salesperson has registered a task, the achievement used as the comparison target for the registered task is displayed. The achievements used as the comparison target may also be the past achievements of the same insurance salesperson with the user ID who has logged in or may also be the past achievements of another insurance salesperson. For example, in the comparison achievement information 37, the average of the achievements of the insurance salesperson with the logged in user ID in a predetermined time period may also be stored. Furthermore, for example, in the comparison achievement information 37, the achievement of the task performed by the insurance salesperson whose performance is excellent may also be stored as a sample.

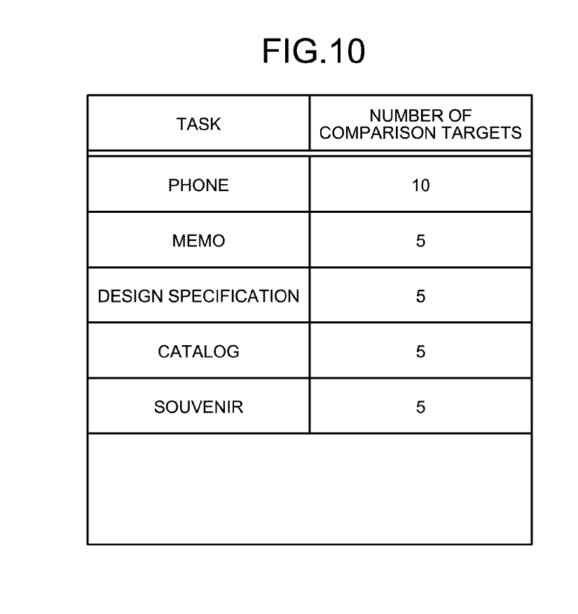

FIG. 10 is a schematic diagram illustrating an example of the data structure of the comparison achievement information. As illustrated in FIG. 10, the comparison achievement information 37 includes items, such as the “task”, the “number of comparison targets”, and the like. Furthermore, each of the items included in the comparison achievement information 37 illustrated in FIG. 10 is an example and another item may also be included.

The item of the task is an area that stores therein the type of tasks used as the comparison target. The number of comparison targets is an area that stores therein the number of processed cases of the achievements of the tasks used as the comparison target. For example, the example illustrated in FIG. 10 indicates that, regarding the task of the phone, the number of processed cases of the achievements used as the comparison target is “10”.

The automatic additional task information 38 is the data that stores therein information related to the task that can be automatically added. Here, in some cases, the insurance salesperson may possibly register an important task, such as the task related to a customer, or the like, in the schedule; however, an arbitrary task, such as the task related to the insurance salesperson is not registered. Thus, in the embodiment, the predetermined arbitrary tasks that are periodically performed can be automatically added to the schedule.

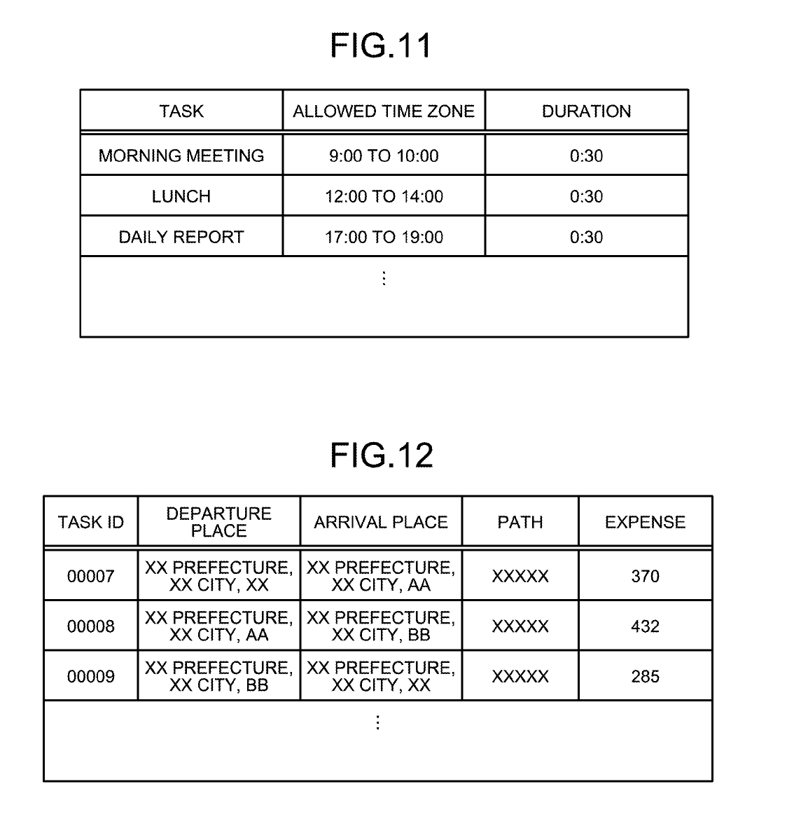

FIG. 11 is a schematic diagram illustrating an example of the data structure of the automatic additional task information. As illustrated in FIG. 11, the automatic additional task information 38 includes items, such as the “task”, the “allowed time zone”, the “duration”, and the like. Furthermore, each of the items included in the automatic additional task information 38 illustrated in FIG. 11 is an example and another item may also be included.

The item of the task is an area that stores therein the type of tasks that can be automatically added. The item of the allowed time zone is an area that stores therein the time zone in which addition of a task is allowed. The item of the duration is an area that stores therein the time of duration needed for the task. For example, the example illustrated in FIG. 11 indicates that, if a 30-minute spare time is present in the time zone between 9:00 and 10:00, the task of the morning meeting can be automatically added.

The move information 39 is the data that stores therein the information related to the task of a move. Here, the insurance salesperson moves due to a customer visit, or the like. The move information 39 stores therein the information related to the task of a move, such as a visit to a customer, or the like.

FIG. 12 is a schematic diagram illustrating an example of the data structure of the move information. As illustrated in FIG. 12, the move information 39 includes items, such as the “task ID”, the “departure place”, the “arrival place”, the “path”, the “expense”, and the like. Furthermore, each of the items included in the move information 39 illustrated in FIG. 12 is an example and another item may also be included.

The item of the task ID is an area that stores therein the task ID of the task of a move. The item of the departure place is an area that stores therein the departure place of the move. The item of the arrival place is an area that stores therein the arrival place of the area. The item of the path is an area that stores therein the moving path from the departure place to the arrival place. The item of the expense is an area that stores therein the expense of a move from the departure place to the arrival place. For example, the example illustrated in FIG. 12 indicates that, regarding the task of the move with the task ID of “00007”, the departure place is “XX prefecture, XX city, XX”, the arrival place is “XX prefecture, XX city, AA”, the moving path is “XXXXX”, and the expense is “370” yen.

The control unit 22 is a device that controls the server device 12. As the control unit 22, an electronic circuit, such as a central processing unit (CPU), a micro processing unit (MPU), and the like, or an integrated circuit, such as an application specific integrated circuit (ASIC), a field programmable gate array (FPGA), and the like, may be used. The control unit 22 includes an internal memory that stores therein control data and programs in which various kinds of procedures are prescribed, whereby the control unit 22 performs various kinds of processes. The control unit 22 functions as various kinds of processing units by various kinds of programs being operated. For example, the control unit 22 includes a display control unit 50, a reception unit 51, a registration unit 52, and an acquiring unit 53.

The display control unit 50 controls a display of various kinds of information. For example, when the display control unit 50 receives an access from the user terminal 11, the display control unit 50 performs control of sending information on various kinds of operation screens to the user terminal 11 corresponding to the access source and displaying the operation screens on the user terminal 11 corresponding to the access source. For example, the display control unit 50 displays the login screen on the user terminal 11 in accordance with an access from the user terminal 11 and receives a login by allowing a user to input the user ID. If the login has been successful, the display control unit 50 controls a display of various kinds of screens, such as operation screens, or the like, on the user terminal 11. For example, the display control unit 50 displays, on the user terminal 11, a schedule screen on which the schedule of the insurance salesperson with the input user ID has been displayed.

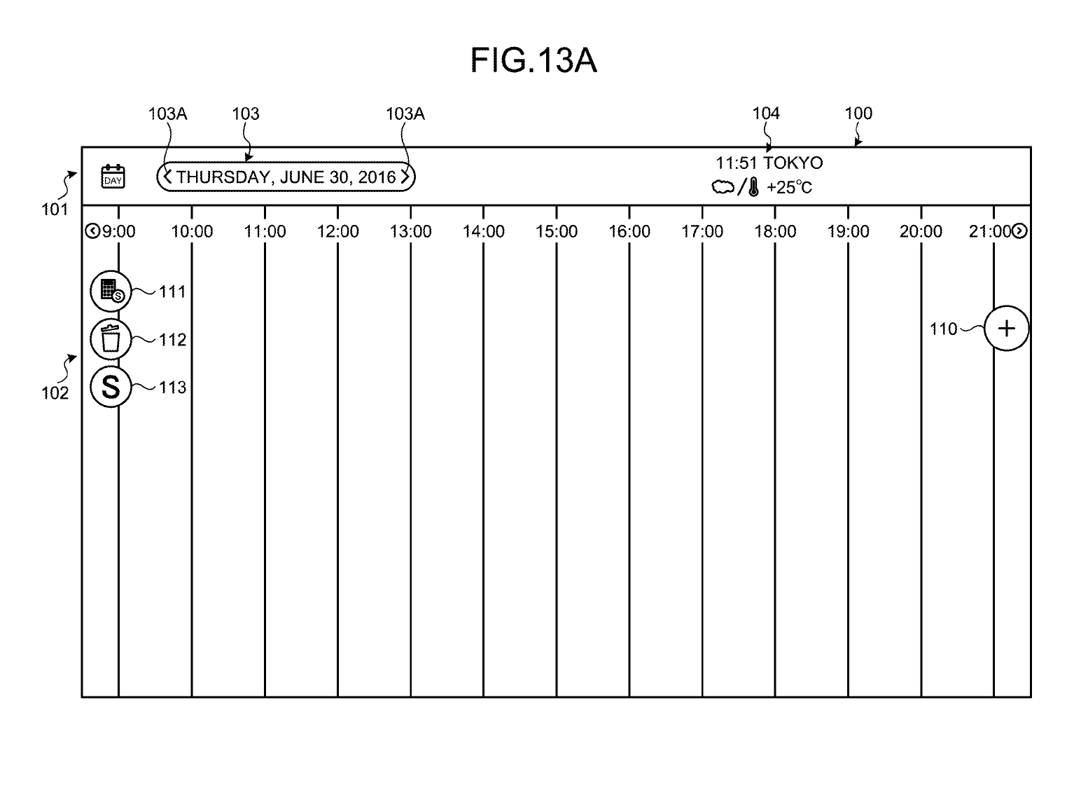

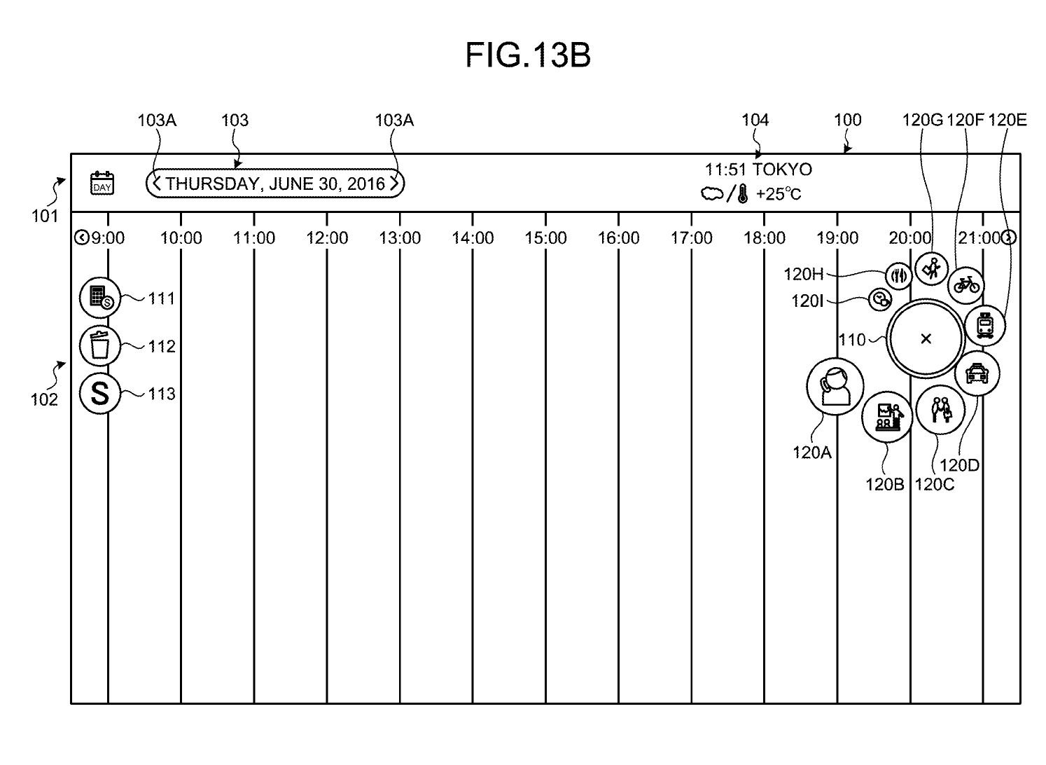

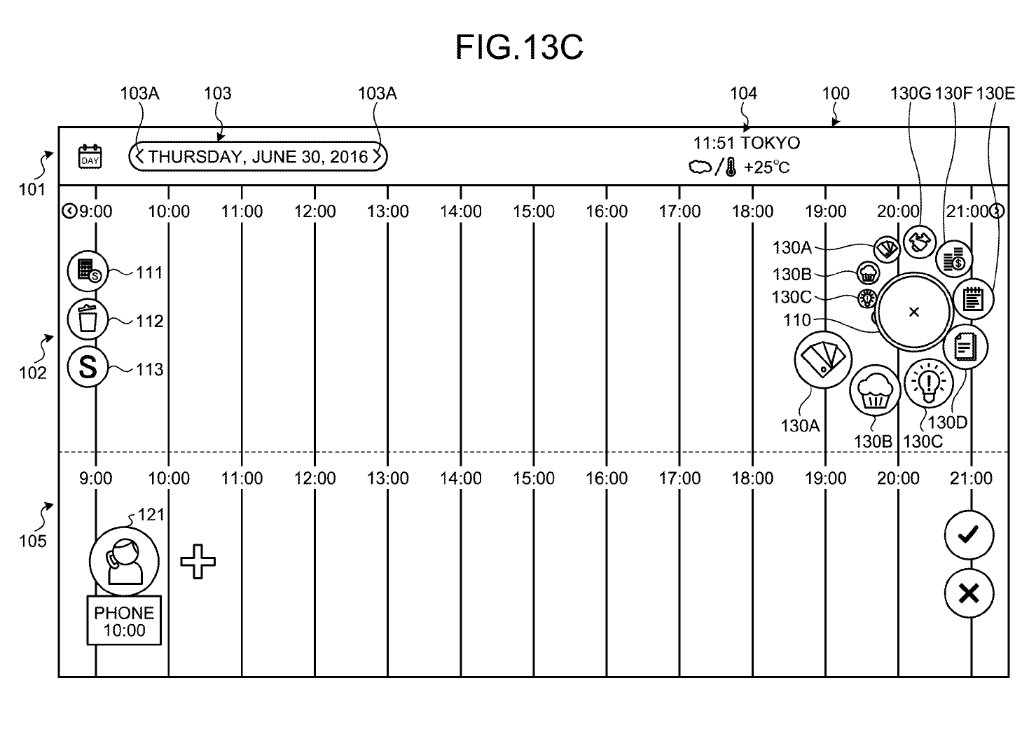

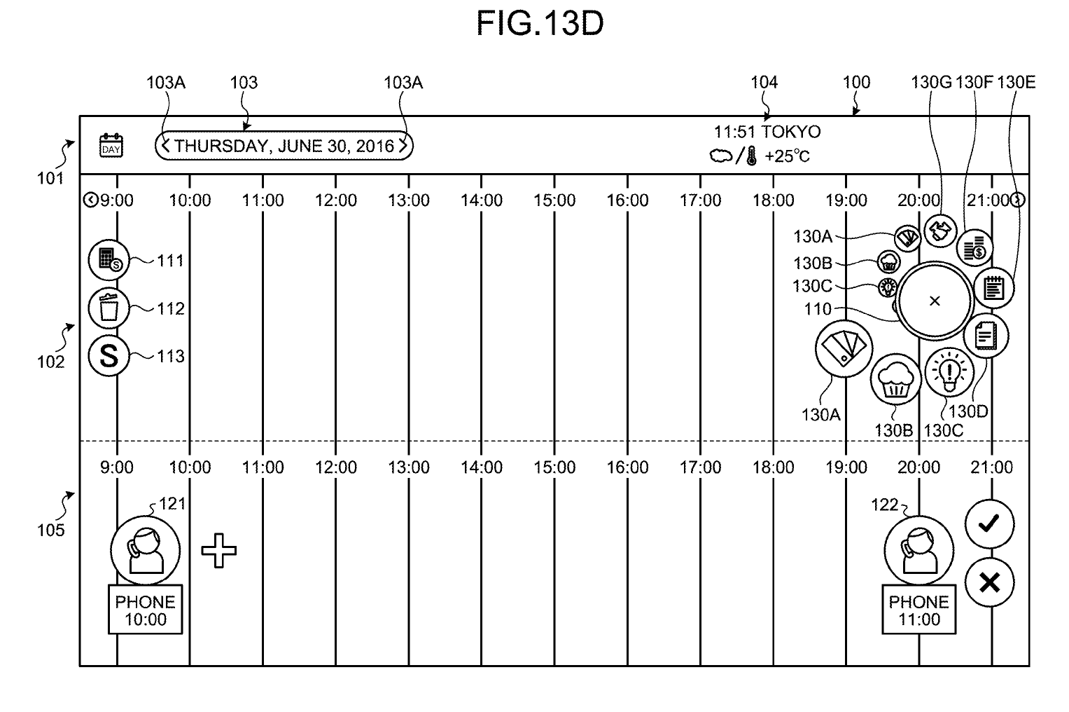

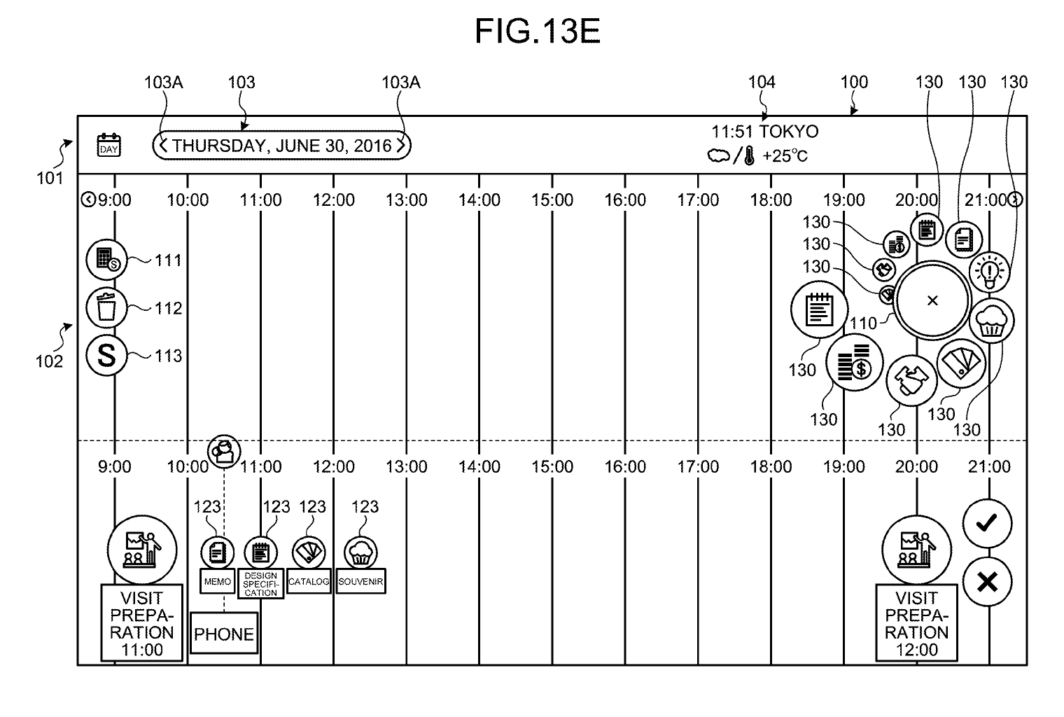

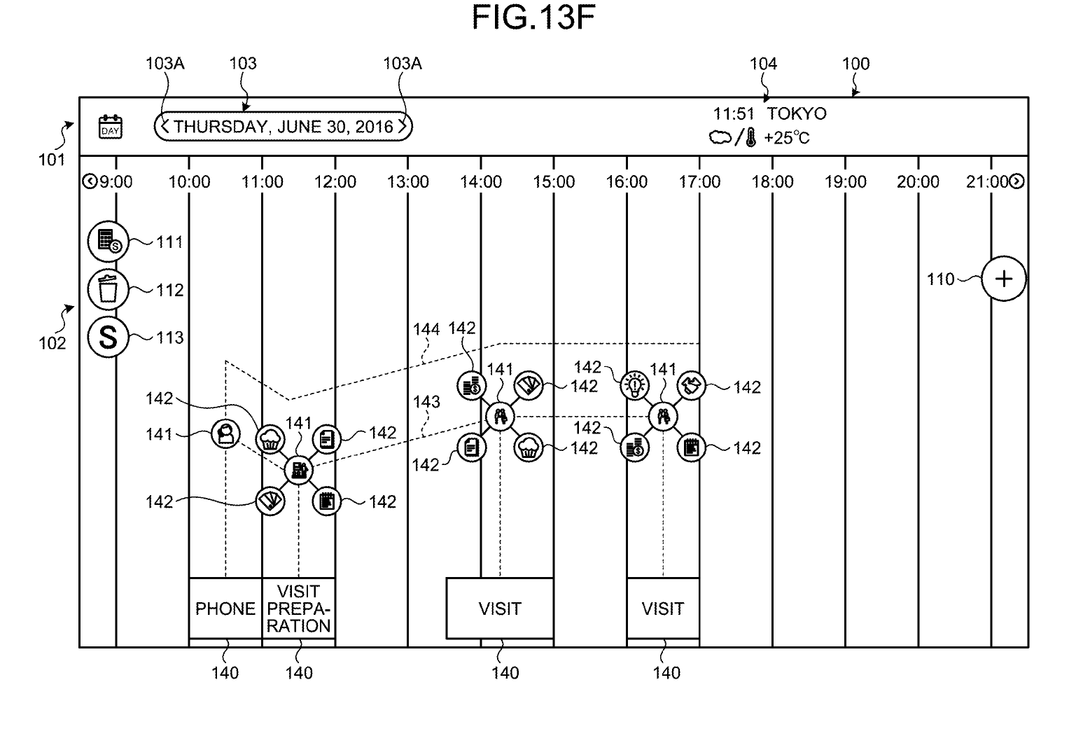

FIG. 13A is a schematic diagram illustrating an example of the schedule screen. The example illustrated in FIG. 13A indicates an example of the schedule screen displayed on the user terminal 11. A schedule screen 100 includes a header area 101 provided in the upper portion of the schedule screen 100 and a main area 102 on which the schedule is displayed. The header area 101 includes a date area 103 that is used to display the date and a weather display area 104 that is used to display weather information.

In the date area 103, the date of a logged in date is displayed as the initial display. Furthermore, the date area 103 includes switch icons 103A on both sides of the date and the date to be displayed can be changed by the switch icons 103A. In the main area 102, the schedule of the date displayed on the date area 103 is displayed. The insurance salesperson can also check the schedule of the dates in the past and the future by changing the displayed date by operating the switch icons 103A.

In the weather display area 104, the weather information associated with the location of the user terminal 11 is displayed. For example, the display control unit 50 acquires the location information on the user terminal 11 from the user terminal 11 and displays, on the weather display area 104 from an external server that provides the weather information, the weather information associated with the location indicated by the location information related to the user terminal 11.

In the main area 102, the times are sequentially displayed in the lateral direction and the flow of time is exhibited. Furthermore, the main area 102 includes a menu icon 110, an expense icon 111, a trash icon 112, and a simulation icon 113.

The menu icon 110 is an icon that gives the instruction to display the task that can be registered in the schedule. The expense icon 111 is an icon that gives the instruction to display the expense incurred. The trash icon 112 is an icon used to delete the task. In the embodiment, the task targeted for the deletion is deleted from the schedule by moving the task targeted for the deletion to the trash icon 112 while maintaining the selection state and by resetting the selection. The simulation icon 113 is an icon that gives the instruction to add the task that can be automatically added to the schedule.

The reception unit 51 receives various kinds of operations. For example, by receiving various kinds of operation information on the operation screens from the user terminal 11, the reception unit 51 receives various kinds of operations. For example, the reception unit 51 receives various kinds of operations related to the schedule in accordance with the operation performed on the schedule screen 100. For example, the reception unit 51 receives an instruction to display the task that can be registered in the schedule by the selection operation of the menu icon 110 on the schedule screen 100.

When the display control unit 50 receives the selection operation of the menu icon 110, the display control unit 50 displays the task that can be added to the schedule on the schedule screen 100 in accordance with the menu information 33.

FIG. 13B is a schematic diagram illustrating an example of the schedule screen. The example illustrated in FIG. 13B indicates the state in which the selection operation of the menu icon 110 has been performed. For example, as illustrated in FIG. 13B, if no task is selected, the display control unit 50 reads, from the menu information 33, the tasks in each of which the item of the selected task is “nil”. Then, the display control unit 50 displays icons 120 (120A to 120I) indicating the read tasks around the menu icon 110 in the order of the “order”. The icon 120A indicates a phone task. The icon 120B indicates a visit preparation task. The icon 120C indicates a customer visit task. The icon 120D indicates a move-by-taxi task. The icon 120E indicates a move-by-train task. The icon 120F indicates a move-by-bicycle task. The icon 120G indicates a move-on-foot task. The icon 120H indicates a lunch task. The icon 120I indicates a rest task.

The reception unit 51 receives a selection of the task to be added to the schedule. For example, due to the selection operation of the icons 120A to 1201 on the schedule screen 100, the reception unit 51 receives a selection of the task to be added to the schedule from among the several types of tasks. Furthermore, the reception unit 51 receives the designation of the start time and the end time of the task to be added to the schedule. For example, the reception unit 51 receives the designation of the start time and the end time by moving the icon of the task to be added to the schedule to the position of the time while maintaining the selection state of the icon of the task.

For example, if the insurance salesperson adds a task to the schedule, the insurance salesperson moves the task to be added to the position of the start time while maintaining the selection state of the task and resets the selection. FIG. 13C is a schematic diagram illustrating an example of the schedule screen. The example illustrated in FIG. 13C indicates the state in which the operation of moving the icon 120A to 10:00 is performed while maintaining the selection state of the icon 120A and the phone task is added to the schedule at 10:00 as the start time. The display control unit 50 displays a sub area 105, in the lower half of the main area 102, that is used to perform the setting related to the added task. In also the sub area 105, the times are sequentially displayed in the lateral direction. In the example illustrated in FIG. 13C, the start time of 10:00 is displayed on the sub area 105 together with an icon 121 of the phone task.

In the sub area 105, the end time of the added task can be designated. Furthermore, in the sub area 105, the task that is accompanied by being associated with the added task can be designated. If a task is selected from the menu icon 110 and the task is added, the display control unit 50 displays a task that is frequently accompanied by being associated with the added task as the task that can be added. For example, as illustrated in FIG. 13C, if the phone task is selected, the display control unit 50 reads the tasks in each of which the item of the selected task is the “phone” from the menu information 33. Then, the display control unit 50 displays icons 130 (130A to 130G) indicating the read tasks around the menu icon 110 in the order of the “order”. The icon 130A indicates the task of preparing an insurance catalog. The icon 130B indicates the task of preparing a souvenir. The icon 130C indicates the task of registering the content to be reported to a customer. The icon 130D indicates the task of registering the content of the memo. The icon 130E indicates the task of preparing the design specification of insurance. The icon 130F indicates the task of registering the expenditure. The icon 130G indicates the task of registering the content of the commitment with the customer.

If the insurance salesperson designates the end time of the added task, the insurance salesperson moves the icon 121 displayed on the sub area 105 to the position of the end time while maintaining the selection state of the icon 121 and resets the selection. FIG. 13D is a schematic diagram illustrating an example of the schedule screen. The example illustrated in FIG. 13D indicates the state in which the operation of moving the icon 121 to 11:00 is performed in the selection state of the icon 121 and the end time of the phone task is designated at 11:00. The display control unit 50 displays, on the sub area 105, the end time of 11:00 together with an icon 122 of the phone task.

Furthermore, when associating the task accompanied by the task that is added to the schedule, the insurance salesperson moves the task to be accompanied to the position of the sub area 105 while maintaining the selection state of the task to be accompanied and resets the selection. FIG. 13E is a schematic diagram illustrating an example of the schedule screen. The example illustrated in FIG. 13E indicates the state in which each of the tasks of the memo, the design specification, the catalog, and the souvenir is associated with the visit preparation task. The display control unit 50 displays, on the sub area 105, an icon 123 of each of the tasks of the memo, the design specification, the catalog, and the souvenir.

When the registration unit 52 receives an addition of a task to the schedule from the reception unit 51, the registration unit 52 registers the added task in the storage unit 21. For example, if a main task is added, the registration unit 52 attaches a unique task ID to the added main task. Then, the registration unit 52 registers, in the main schedule information 34, the user ID of the insurance salesperson who has registered the task, the task ID of the added main task, the main task, the start date and time of the main task, and the end date and time of the main task. Furthermore, if the customer targeted for the main task is designated, the registration unit 52 registers the customer ID of the customer targeted for the task in the main schedule information 34, whereas, if the target customer is not designated, the registration unit 52 registers the customer ID as “-” in the main schedule information 34. The designation of the target customer will be described later. Furthermore, the registration unit 52 registers a record in the task information 36 by using the task ID of the added main task.

Furthermore, for example, if a subtask is added, the registration unit 52 attaches a unique task ID to the added subtask. Then, the registration unit 52 registers, in the sub schedule information 35, the task ID of the main task with which the added subtask is associated, the task ID of the subtask, and the subtask. Furthermore, if the customer targeted for the subtask is designated, the registration unit 52 registers the subtask in the sub schedule information 35 for each customer ID of the customer targeted for the task, whereas, if the target customer is not designated, the registration unit 52 registers the subtask by using the customer ID as “-” in the sub schedule information 35. Consequently, if the subtasks are added, the main task and each of the subtasks are associated with each other and are stored as the schedule in the storage unit 21.

After the tasks have been registered in the schedule on the schedule screen 100, if the main area 102 is selected, the display control unit 50 displays the registered tasks on the main area 102. For example, the display control unit 50 displays the registered main task. Furthermore, if the subtasks accompanied by the main task have been registered, the display control unit 50 associates the subtasks with the main task and displays the subtasks. FIG. 13F is a schematic diagram illustrating an example of the schedule screen. The example illustrated in FIG. 13F indicates the state in which the tasks of the phone, the visit preparation, and the two visits have been registered as the main task. The display control unit 50 displays, for each of the registered main tasks at the position in the length associated with the time zone of each of the main tasks, the schedule bar that displays bars 140 in each of which the title associated with the main task is displayed. For example, the display control unit 50 displays the bars 140 in the range of the time of the main area 102 associated with the start date and time and the end date and time of each of the main tasks. Furthermore, the display control unit 50 displays, for each main task, an icon 141 of the corresponding main task by being associated with the corresponding bar 140. Furthermore, if the subtasks accompanied by the main task have been registered, the display control unit 50 displays icons 142 of the accompanying subtasks around the icon 141 of the corresponding main task.

In the task registered in the schedule, the target number of cases to be processed by an insurance salesperson can be set as a target value. The target number of cases may also be automatically set based on the past achievements of the insurance salesperson, may also be set by using a fixed value, or may also be registered by the insurance salesperson. For example, the target number of cases of each of the tasks may also be the average value or the maximum value of the achievements of the same task performed by the insurance salesperson in a past predetermined time period. Furthermore, the target value of each of the tasks may also be registered by the insurance salesperson when registering the task by displaying the operation screen, such as a software keyboard, in which a value can be input. The registration unit 52 registers the target number of cases of the tasks in the task information 36.

In the embodiment, the icons 141 of the main tasks are displayed on the schedule screen 100 in accordance with the target height.

The acquiring unit 53 acquires various kinds of information. For example, the acquiring unit 53 acquires, for each main task, the target number of cases of the main tasks from the task information 36. Furthermore, if subtasks have been registered by being associated with the main task, the acquiring unit 53 also acquires the target number of cases of the subtasks associated with the main task from the task information 36.

The display control unit 50 applies, for each main task, a predetermined weighting in accordance with the type of tasks, performs weighting addition of the target number of cases, and obtains the target value for each main task. The display control unit 50 displays the icons 141 of the main tasks at the height of each of the calculated target values. The example illustrated in FIG. 13F indicates a line 143 connecting each of the icons 141 of the main tasks in accordance with the height of each of the target values.

Furthermore, in the embodiment, the past achievements related to the main tasks are displayed on the schedule screen 100.

For example, the acquiring unit 53 acquires, for each main task, the number of processed cases of the achievements of the comparison target of each of the main tasks from the comparison achievement information 37. Furthermore, if the subtasks have been registered by being associated with the main task, the acquiring unit 53 also acquires, from the comparison achievement information 37, the number of processed cases of the achievements of the comparison target of the subtasks that are associated with the main task.

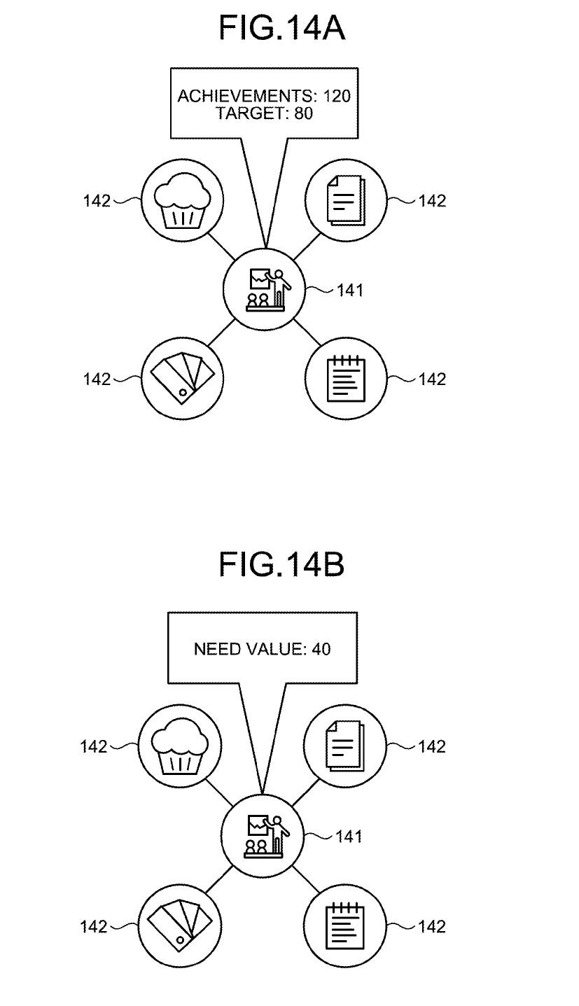

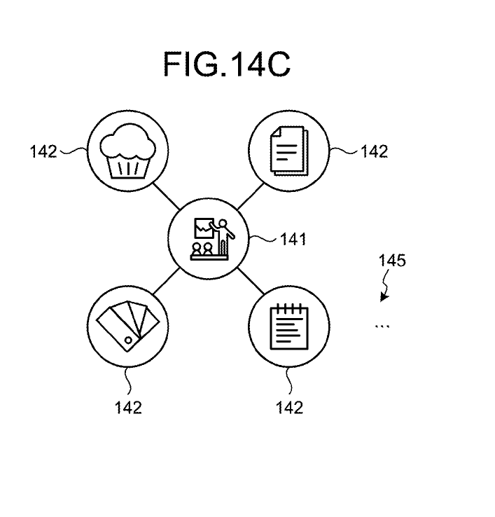

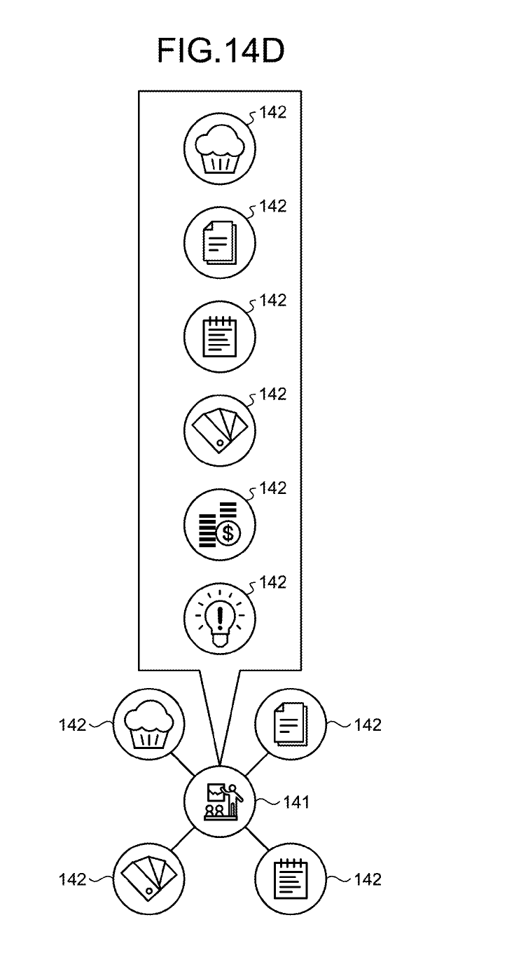

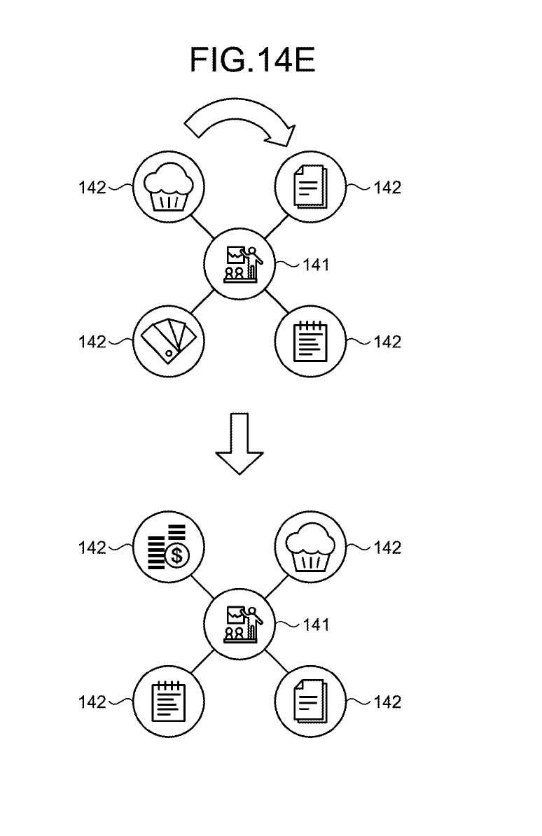

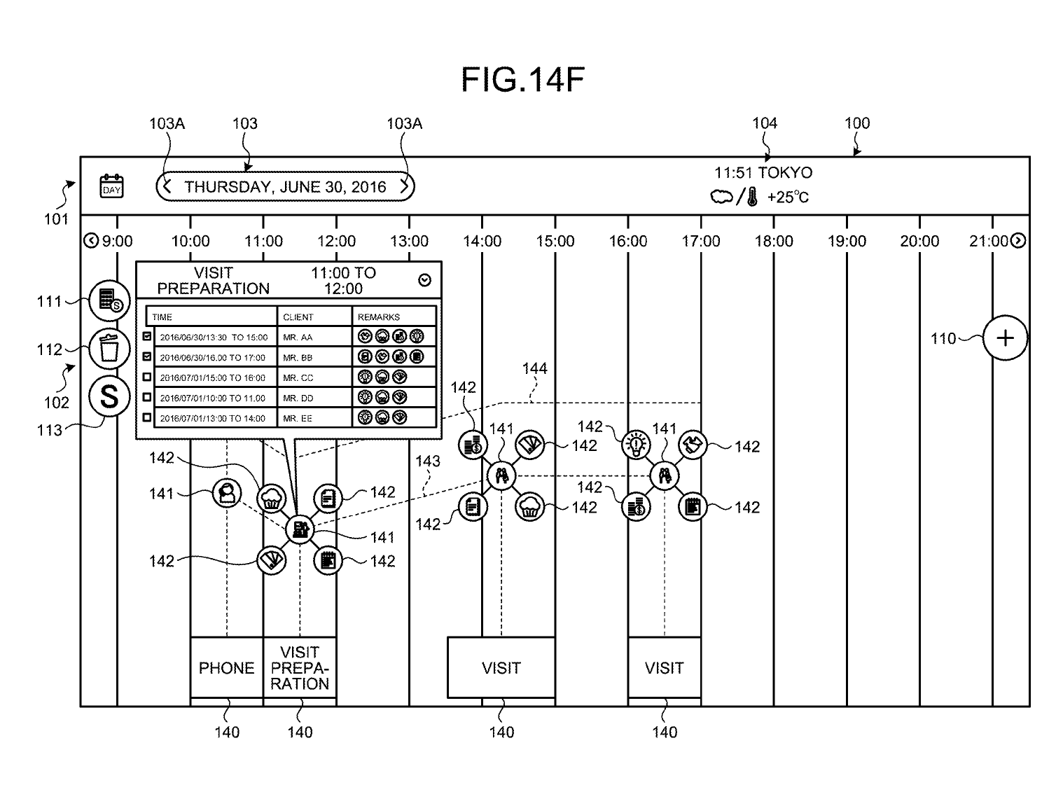

The display control unit 50 applies, for each main task, a predetermined weighting in accordance with the type of tasks, adds the weighting of the number of processed cases of the achievements, and obtains an achievement value for each main task. The display control unit 50 displays the past achievements at the position of the same time as that of the icon 141 of the main task at the height in accordance with each of the calculated achievement values. The example illustrated in FIG. 13F indicates a line 144 connecting each of the past achievements in accordance with the height of the achievement values. Furthermore, the display control unit 50 may also display the target value of the task and the achievement value. FIG. 14A is a schematic diagram illustrating an example of a display of the target value and the achievement value of the task. The example illustrated in FIG. 14A indicates a case of displaying the target value and the achievement value related to the main task.

The reception unit 51 receives an operation of registering the expense incurred in the task registered in the schedule. Regarding the task in which the expense has been registered, the registration unit 52 registers the registered expense in the item of the expense in the task information 36. Furthermore, the reception unit 51 receives an operation of the completion of the process of the task registered in the schedule. Regarding the task in which the operation of the completion of the process has been received, the registration unit 52 registers “completed” in the item of the processing status in the task information 36.

Furthermore, regarding the task registered in the schedule, the reception unit 51 may also receive an input of the information related to the execution of the task, such as the number of processed cases. If the information related to the execution of the task is input, the display control unit 50 may also update and display a remaining need value needed to reach the target value. FIG. 14B is a schematic diagram illustrating an example of a display of the need value of the task. The example illustrated in FIG. 14B indicates a case of displaying the remaining need value related to the main task needed to reach the target value.

Furthermore, the reception unit 51 may also receive the setting of the target by changing the height of the icon 141 of the main task displayed on the schedule screen 100. For example, it is assumed that, the display position of the icon 141 of the task can be changed. If the height of the icon 141 of the task is changed, the registration unit 52 changes and registers the target number of cases of the tasks in accordance with the changed height. For example, the registration unit 52 divides the changed target value by the predetermined weighting that is in accordance with the type of tasks in which the target value has been changed, obtains the target number of cases of the tasks, and registers the obtained result in the task information 36. Furthermore, if the target value of the main task by which the subtask is accompanied has been changed, the registration unit 52 may also register the changed target value as the target number of cases of the main task in the task information 36.

If a lot of subtasks are associated with the main task and the associated subtasks are not able to be displayed around the main task, the display control unit 50 displays a character or a mark that allows presence or absence of undisplayed task to be identified. FIG. 14C is a schematic diagram illustrating an example of displaying whether an undisplayed task is present. In the example illustrated in FIG. 14C, a mark 145 indicating that the subtask undisplayed with respect to the main task is present.

If the mark 145 is selected, the display control unit 50 displays the subtasks. FIG. 14D is a schematic diagram illustrating an example of a display of subtasks. In the example illustrated in FIG. 14D, the icons 142 of the accompanying subtask associated with the main task are displayed as a popup balloon.

Furthermore, the display control unit 50 may also display the undisplayed subtasks by moving the subtasks that are arranged and displayed around the main task. FIG. 14E is a schematic diagram illustrating an example of a display of the subtasks. In the example illustrated in FIG. 14E, the undisplayed subtasks are displayed around the main task by rotating the subtasks around the main task.

Furthermore, it is possible for the reception unit 51 to receive the customer targeted for the process of the task. For example, regarding the main task registered in the schedule, the reception unit 51 receives the customer targeted for the process. Fr example, the display control unit 50 reads, from the customer information 31, the customers handled by the insurance salesperson with the logged in user ID and displays the list of the customers. The reception unit 51 receives the customer targeted for the process from the list of the customers. The registration unit 52 registers the customer ID of the customer targeted for the process in the item of the customer ID in the main schedule information 34. Furthermore, regarding the customer targeted for the process, the reception unit 51 may also receive, for each customer, the registration of the subtasks. FIG. 14F is a schematic diagram illustrating an example of the schedule screen. In the example illustrated in FIG. 14F, a plurality of customers has been registered regarding the main task of the visit preparation, the customers that have been registered by being associated with the icon 141 of the main task of the visit preparation are displayed as a popup balloon. Furthermore, the icon of the subtask registered as “remarks” is displayed for each customer. For example, by moving the subtask to be added from the menu icon 110 to the position of “remarks” while maintaining the selection state of the subtask to be added and by resetting the selection, the reception unit 51 receives the registration of the subtask. If the customer targeted for the subtask is designated, the registration unit 52 registers the customer for each customer ID of the customer targeted for the task in the sub schedule information 35.

Incidentally, for example, the insurance salesperson registers and manages the tasks, such as a visit preparation for a customer, a visit to a customer, a plan to make a phone to a customer, and the like; however, there may be a case in which the task, such as lunch, a move to the visit destination, a morning meeting, making a daily report, or the like, is not registered as a task.

Thus, in the embodiment, an addition of a task, which can be automatically added, to the schedule is possible. For example, if the insurance salesperson adds the task, which can be automatically added, to the schedule, the insurance salesperson selects the simulation icon 113 on the schedule screen 100.

If the registration unit 52 receives the selection operation of the simulation icon 113 from the reception unit 51, the registration unit 52 adds, based on the automatic additional task information 38, the task, which can be automatically added, to the schedule. For example, the registration unit 52 refers to the automatic additional task information 38 and determines whether the duration of time needed by the task that can be automatically added can be secured, for each registered task that can be automatically added, in the allowed time zone and in the time zone other than the time zone associated with the tasks registered in the schedule. Then, if the duration of time needed by the task that can be automatically added can be secured in the time zone other than the time zone associated with the tasks registered in the schedule, the registration unit 52 automatically registers the subject task in the schedule. The registration unit 52 registers the task that can be automatically added as the main task in the main schedule information 34 and the task information 36.

Furthermore, if the registration unit 52 receives the selection operation of the simulation icon 113 by the reception unit 51, the registration unit 52 automatically adds a move task to the schedule. For example, if the task of visiting a customer is registered in the schedule and there is no task of moving to the address of the subject customer before the task of visiting the customer, the registration unit 52 automatically adds the task of moving to the address of the subject customer. Furthermore, if the task of visiting a customer is registered in the schedule and there is no task of moving to the address of the place of work for the insurance salesperson doing the work, the registration unit 52 automatically adds the task of moving to the address of the place of work. For example, regarding each of the main tasks registered in the schedule, the registration unit 52 specifies the address in which each of the main tasks is performed in accordance with the time. In the embodiment, it is assumed that, regarding a visit task, the address in which the task is performed is the address of the customer corresponding to the visit destination. The registration unit 52 refers to the customer information 31 and specifies the address of the customer corresponding to the visit destination. It is assumed that, regarding the main tasks other than the visit task, the address of the place of work for the insurance salesperson doing the work is the address in which the task is performed. The registration unit 52 refers to the user information 30 and specifies the address of the place of work for the insurance salesperson with the logged in user ID doing the work. Then, the registration unit 52 determines, regarding each of the main tasks registered in the schedule, whether the task of moving to the address in which the subject main task is performed is present before the subject main task. Furthermore, by using the reference location in which the schedule is started and the reference location in which the schedule is ended as the address of the place of work for the insurance salesperson with the user ID doing the work, the registration unit 52 may also determine, in line with the schedule, whether the task of moving to the address of the customer corresponding to the visit destination is present before the visit task or whether there is the task of moving to the address of the place of work is present before the daily report task. For example, the registration unit 52 determines, in line with the schedule, whether there is the task of moving from the reference location in which the schedule is started to the address of the customer corresponding to the visit destination and there is the task of moving from the address of the customer corresponding to the visit destination to the reference location in which the schedule is ended.

If there is no move task, the registration unit 52 automatically registers the task of moving to the address in which the subject task is performed before the task in the schedule. For example, the registration unit 52 uses the external server that provides a search service of a moving path, designates the address of the move source and the address of the move destination, searches for the moving path and the expense, and registers the move task indicating the searched moving path and the expense. For example, the registration unit 52 sets predetermined time (for example, 10 minutes) before the start time of the visit task as the arrival time or sets predetermined time (for example, 10 minutes) after the end time of the task previous to the visit task as the departure time, searches for the moving path, and automatically registers the move task. The registration unit 52 registers each of the move tasks as the main tasks in the main schedule information 34 and the move information 39.

Furthermore, the registration unit 52 may also register the move task first and then register the lunch task. For example, the registration unit 52 sets the predetermined time before the start time of the visit task as the arrival time or sets the predetermined time after the end time of the task previous to the visit task as the departure time, searches for the moving path, and automatically registers the move task. Then, if the duration of time needed by the lunch task can be secured in the time zone other than that associated with the task registered in the schedule, the registration unit 52 may also register the lunch task.

Incidentally, a user may sometimes have an action characteristic of the action taken for the schedule. For example, in a case of a visit, some insurance salesperson has the action characteristic of moving to the visit destination immediately after the end of the previous task or some insurance salesperson has the action characteristic of moving to the visit destination immediately before the start time of the visit.

Thus, the registration unit 52 may also register the task in accordance with the action characteristic of the user or the set rule. For example, the registration unit 52 may also perform control such that, in accordance with the action characteristic of the user or the set rule, the move task is registered closer to the estimated time of the completion of the preceding previous task with respect to the move task or the move task is registered closer to the estimated time of the start of the succeeding subsequent task with respect to the move task. The action characteristic of the user may also be set by the user as the rule or may also be obtained from the past schedule. For example, the registration unit 52 reads, from the main schedule information 34, the past schedule of the insurance salesperson with the logged in user ID and specifies the action characteristic of the insurance salesperson. Then, the registration unit 52 may also register the move task based on the specified action characteristic. For example, the registration unit 52 specifies which timing is used for the move tasks in the past predetermined time period (for example, one month) that were performed with respect to the tasks that are present before and after the move task. For example, the registration unit 52 obtains the time interval between the task previous to the move task and the move task and obtains the frequency distribution of the time intervals for each piece of predetermined duration (for example, 5 minutes). Furthermore, the registration unit 52 obtains the time interval between the move task and the task subsequent to the move task and obtains the frequency distribution of the time intervals for each piece of predetermined duration. Then, the registration unit 52 registers the subject move task so as to have the same timing as that of the most frequently appearing timing. For example, if the duration of 6 to 10 minutes is most frequently appears in the time interval between the task previous to the move task and the move task, the registration unit 52 registers the move task by setting the time elapsed after the arbitrary time between 6 to 10 minutes (for example, 8 minutes corresponding to the intermediate time) since the end time of the task previous to the move task as the departure time. Furthermore, the registration unit 52 may also specify, for each predetermined time zone, the action characteristic from the past move tasks included in the time zone and register the move task in accordance with the action characteristic for each time zone. The time zone may also be, for example, the same time intervals, such as time zone at intervals of one hour. Furthermore, the time zone may also be set by considering the lunch time and the time zone other than the lunch time, for example, the time zone before 12:00, 12:00 to 14:00, after 14:00, and the like. Furthermore, the registration unit 52 may also specify the action characteristic from the past move task of moving to the same address as the move task to be added and register the move task based on the specified action characteristic.

Furthermore, the registration unit 52 may also control the moving path in accordance with the action characteristic of the user or the set rule such that the most frequently used transportation is used for the move. For example, the registration unit 52 refers to the move information 39, reads the past path used to move to the same addresses of the move source and the move destination, and obtains the frequency of each of the past used paths for transportation. Furthermore, even if the address of the move source and the address of the move destination do not completely match the addresses of the past move source and the address of the past move destination, a predetermined region, such as the same town, is treated as the same addresses of the move source and the move destination. Then, the registration unit 52 uses the external server that provides the search service of the moving path, designates the most frequently used transportation, the address of the move source, and the address of the move destination, searches for the moving path and the expense, and registers the move task based on the searched moving path and the expense. Consequently, the moving path is searched by way of the transportation that is frequently used to move from the address of the move source to the address of the move destination.

Furthermore, regarding the lunch task, the registration unit 52 may also search the eating place that is a candidate for lunch in accordance with the planned location at the time of the lunch task, associate the information on the searched eating place with the lunch task as the lunch information, and store the associated information in the storage unit 21. For example, the registration unit 52 specifies the address of the arrival place of the move task before the lunch task or the address of the departure place of the move task after the lunch task as the planned location at the time of the lunch task. The registration unit 52 designates the planned location and the time of the lunch task, uses the external server that provides the search service of the eating place, and searches for the eating place that is near the designated location and that is open within the time of the lunch task. The registration unit 52 may also associate the name of the searched eating place, the location of the eating place, the phone number, the menu, or the like with the lunch task as the lunch information and store the associated information in the storage unit 21. Furthermore, the registration unit 52 may also search the eating place in accordance with the action characteristic of the user or the set rule and may also register the lunch task. The action characteristic of the user may also be set by the user as the rule or may also be obtained from the past schedule. For example, the registration unit 52 reads the past schedule of the insurance salesperson with the logged in user ID from the main schedule information 34 and specifies the frequently used genre of the eating place from the lunch information associated with the lunch task. The registration unit 52 may also search, by using the external server that provides the search service of the eating place, the eating place that is closer to the designated location, that is open within the time of the lunch task, and that is included in the most frequently used genre.

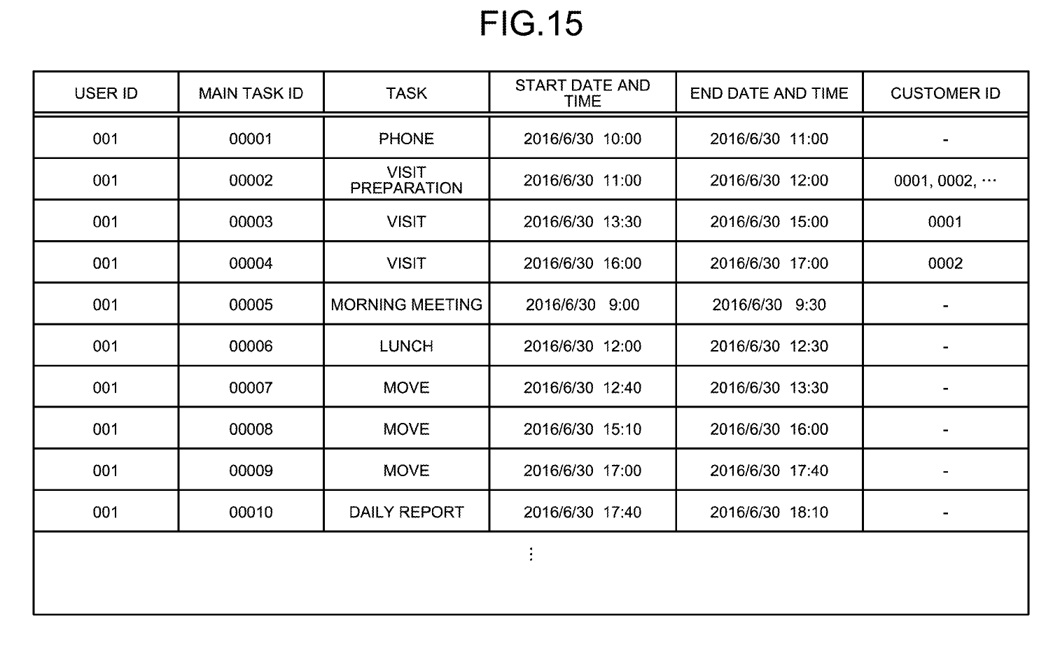

Consequently, for example, when the automatic additional task information 38 is in the state illustrated in FIG. 11, if the 30-minute spare time is present in the time zone between 9:00 and 10:00, the task of the morning meeting is automatically added. Furthermore, if the 30-minute spare time is present in the time zone between 12:00 and 14:00, the lunch task is automatically added. Furthermore, if the 30-minute spare time is present in the time zone between 17:00 and 19:00, the task of the daily report is automatically added. Furthermore, the move task is automatically added. FIG. 15 is a schematic diagram illustrating an example of the data structure on the main schedule information in which tasks are automatically added. The example illustrated in FIG. 15 indicates the state in which the tasks are automatically added from the state illustrated in FIG. 7.

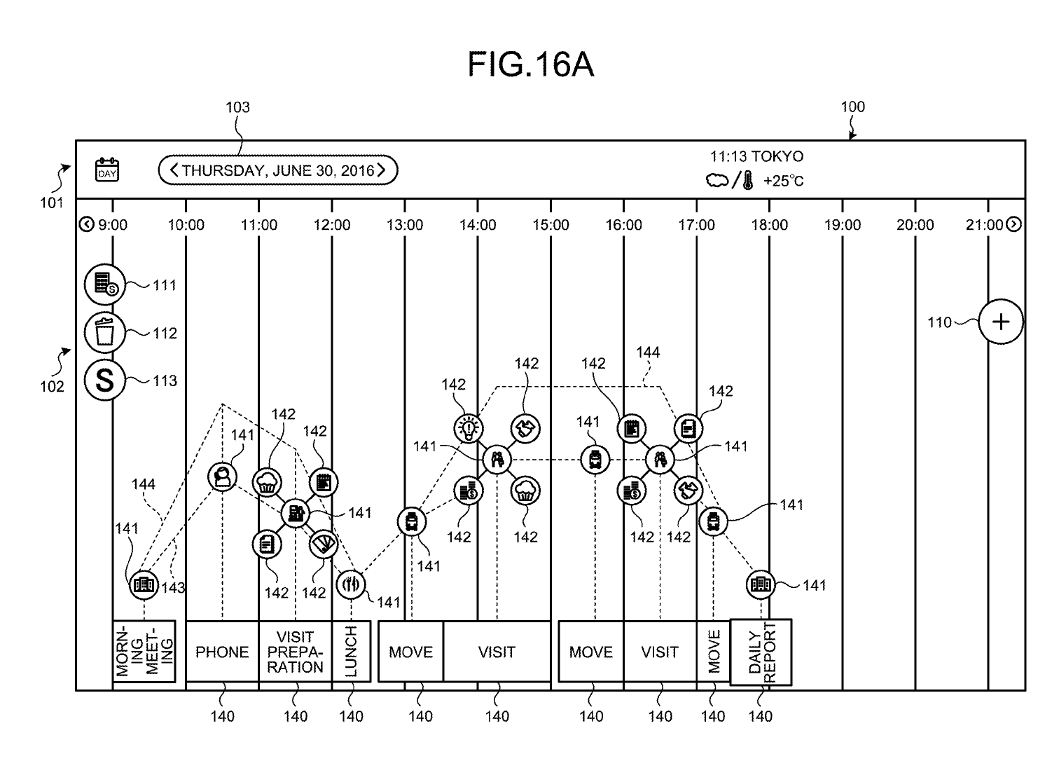

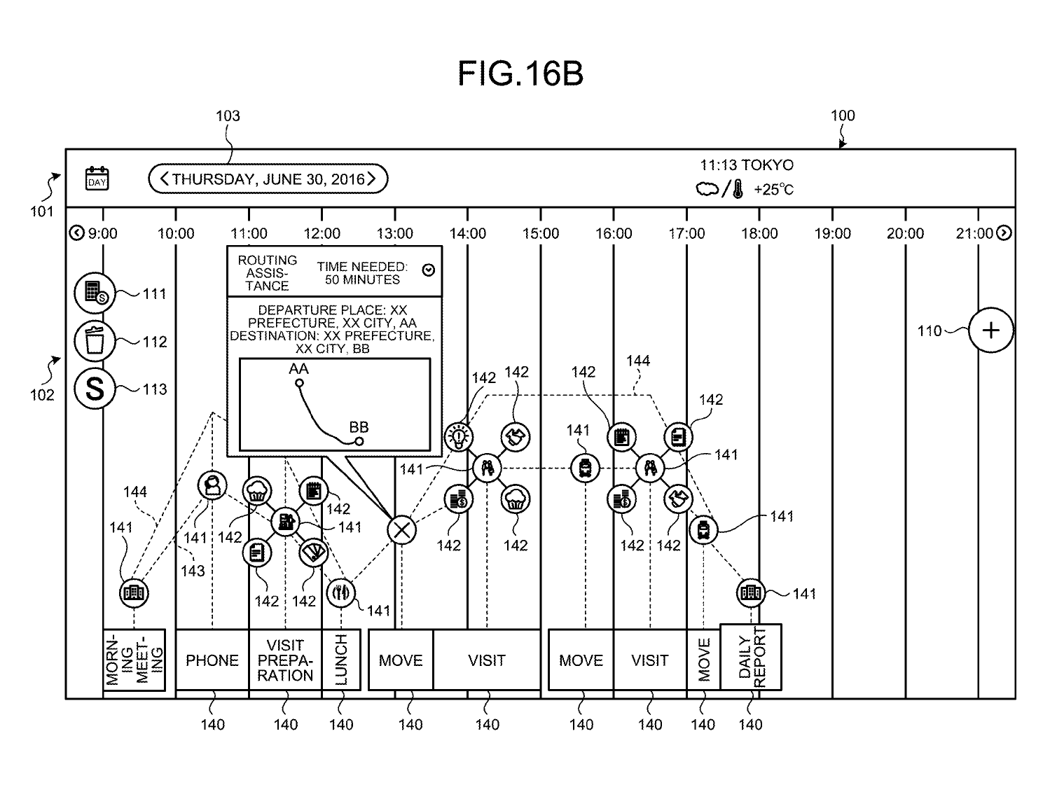

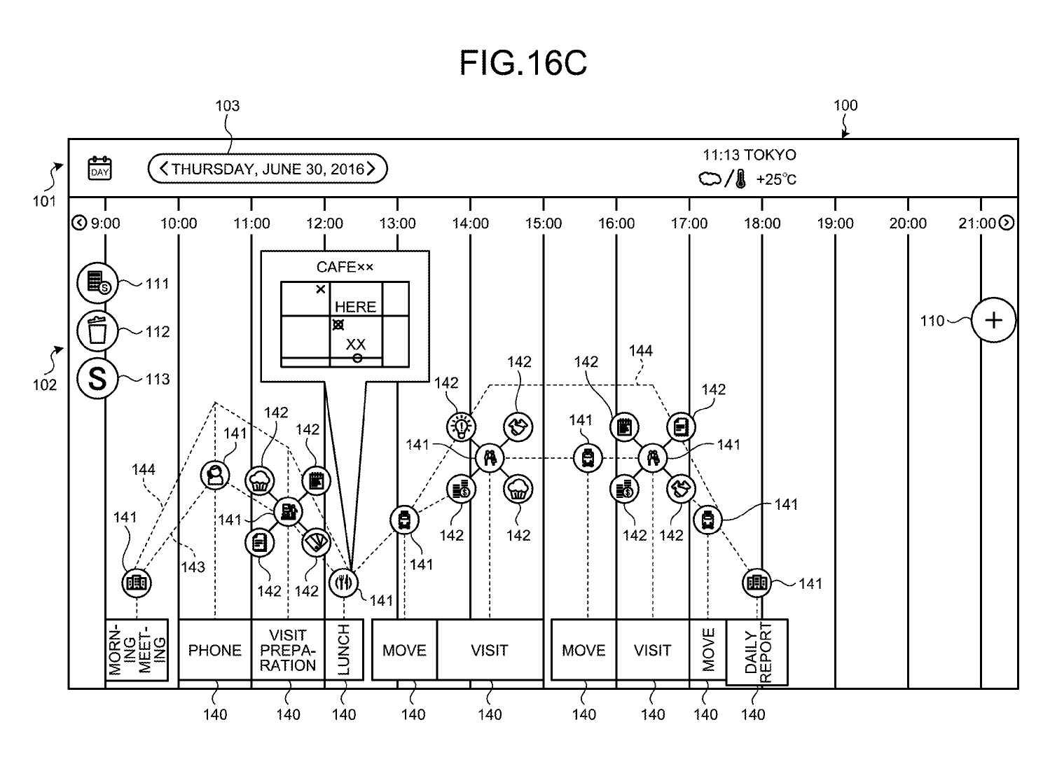

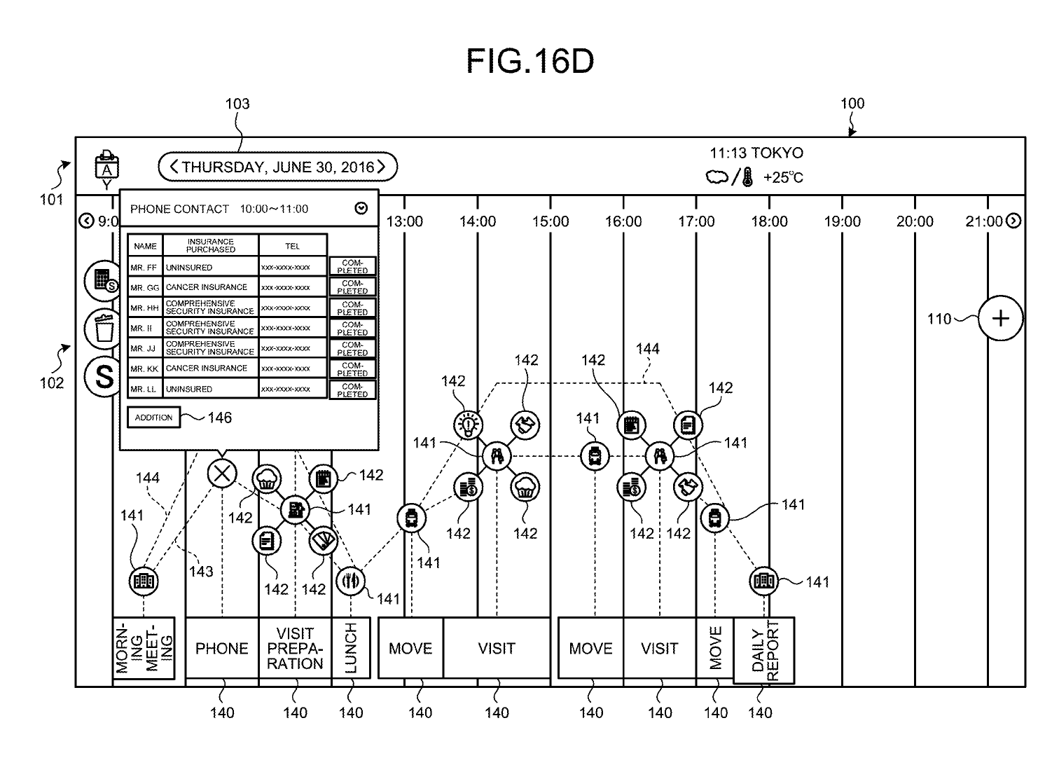

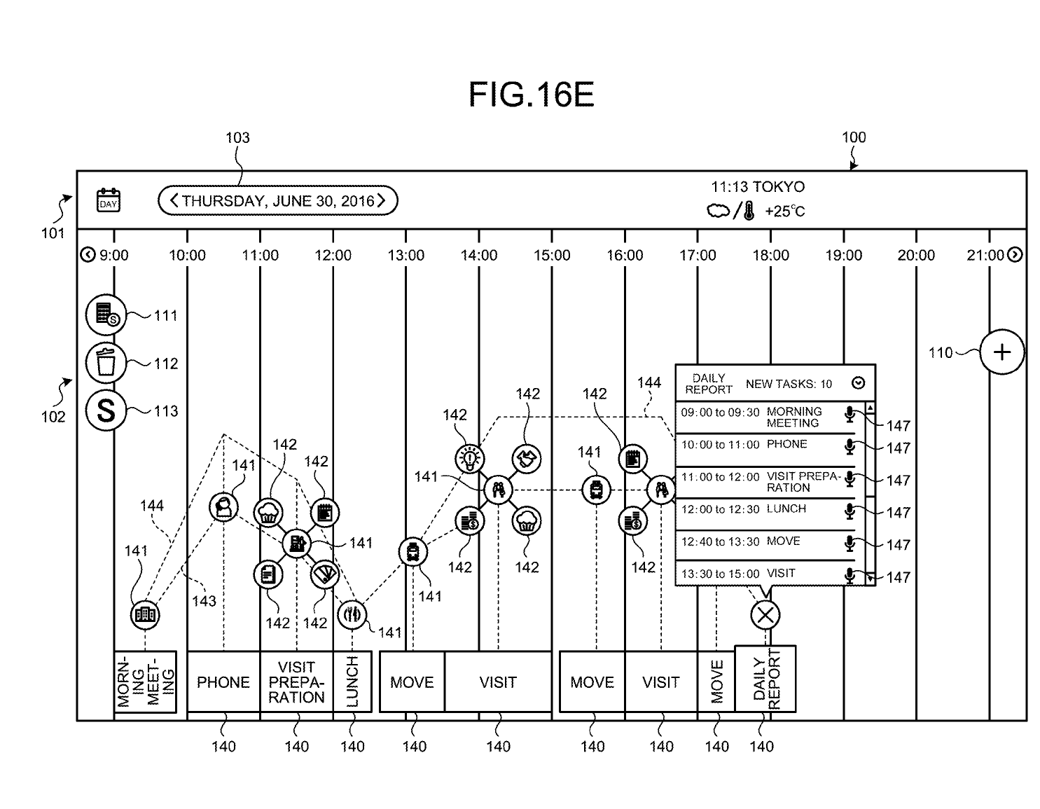

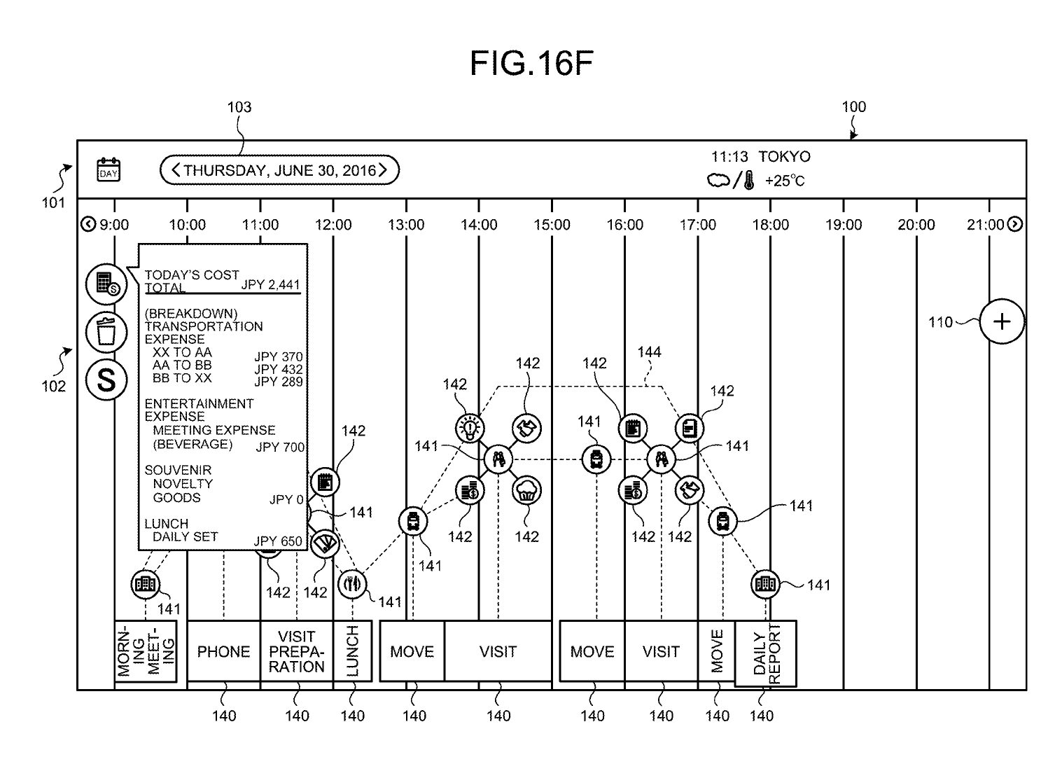

The display control unit 50 displays, on the schedule screen 100, the schedule including the automatically added task. FIG. 16A is a schematic diagram illustrating an example of the schedule screen. In the example illustrated in FIG. 16A, the bars 140 and the icons 141 of the morning meeting, the lunch, the daily report, and the move task are added to the schedule from the state illustrated in FIG. 13F.

By moving the bar 140 of the task displayed on the schedule screen 100 as the selection state, the reception unit 51 receives a change in the start date and time and a change in the end date and time of the task related to the moved bar 140. If the registration unit 52 receives the move of the bar 140 related to the task, the registration unit 52 changes both the start date and time and the end date and time that are related to the task about the moved bar 140 and that are stored in the main schedule information 34 in association with the time at the position of the move destination. Furthermore, for example, if the bar 140 is changed to the position of the earlier time, the registration unit 52 again searches for the moving path by using the time that is associated with the top position of the bar 140 as the departure time and changes the moving path of the move task. Furthermore, if the bar 140 is changed to the position of the later time, the registration unit 52 again searches for the moving path by using the time that is associated with the last position of the bar 140 as the arrival time and changes the moving path of the move task. Furthermore, if the period of time of the moved task and the period of time of the automatically added task are overlapped due to the move of the bar 140, the registration unit 52 may also again register the automatically added task.

If the icon of the task displayed on the schedule screen 100 is selected, the display control unit 50 displays various kinds of information related to the task of the selected icon on the schedule screen 100.

For example, if the icon 141 of the move task is selected, the display control unit 50 reads the moving path of the move task of the selected icon 141 from the move information 39 and displays the moving path. FIG. 16B is a schematic diagram illustrating an example of the schedule screen. In the example illustrated in FIG. 16B, the path map that is associated with the move task and that indicates the moving path is displayed as a popup balloon.

Furthermore, for example, if the icon 141 of the lunch task is in the selection state, the display control unit 50 reads, from the storage unit 21, the lunch information associated with the lunch task of the selected icon 142 and displays the lunch information. FIG. 16C is a schematic diagram illustrating an example of the schedule screen. In the example illustrated in FIG. 16C, the map indicating the name and the location of the eating place is displayed as a popup balloon in an associated manner with the lunch task.

Furthermore, for example, if the icon 141 of the phone task is in the selection state, the display control unit 50 displays the information on the customer targeted by the insurance salesperson with the logged in user ID making a phone contact on the date of the schedule. For example, the display control unit 50 reads, from the phone contact information 32, the customer ID of the customer targeted by the insurance salesperson with the logged in user ID making a phone contact on the date of the schedule, the insurance purchased by the customer, and the status of the phone contact. Furthermore, the display control unit 50 reads, from the customer information 31, the customer name and the phone number associated with the customer ID. Then, the display control unit 50 displays the customer name of the customer targeted for the phone contact, the insurance purchased by the customer, the phone number, and the status of the phone contact. FIG. 16D is a schematic diagram illustrating an example of the schedule screen. In the example illustrated in FIG. 16D, the customer name of each of the customers targeted for making a phone contact in an associated manner with the phone task, the insurance purchased by the customers, the phone numbers, and the status of the phone contact are displayed as a popup balloon. In the embodiment, by selecting an addition button 146, a customer targeted for the phone contact can be added.

Furthermore, for example, if the icon 141 of the daily report task is in the selection state, the display control unit 50 displays information that supports the creation of the daily report. For example, the display control unit 50 displays the task registered in line with the schedule, the time of the start date and time of the task, and the time of the end date and time of the task. FIG. 16E is a schematic diagram illustrating an example of the schedule screen. In the example illustrated in FIG. 16E, each of the tasks registered by being associated with the daily report task, the time of the start date and time of the tasks, and the time of the end date and time of the tasks are displayed as a popup balloon. Furthermore, in each of the tasks, a voice input button 147 is provided and a note obtained from a conversation with the customer by voice can be input. The content input by voice is converted to the form of text by voice recognition and is output, by a predetermined operation, as a report together with the displayed content of each of the tasks displayed as a popup balloon.

Furthermore, for example, if the icon 141 of the morning meeting task is in the selection state, the display control unit 50 displays a message of the news item from the company that is notified by the system in the insurance company.

Furthermore, for example, if the expense icon 111 is in the selection state, the display control unit 50 displays the expense incurred in each of the tasks registered in the schedule. FIG. 16F is a schematic diagram illustrating an example of the schedule screen. In the example illustrated in FIG. 16F, the expenses incurred in each of the tasks registered in the schedule by being associated with the expense icon 111 are displayed as a popup balloon. The expenses incurred in each of the tasks can be totalized every week, every month, every year, or the like on another cost screen and can be output as the data that can be used for a tax return.

In the embodiment, from among the tasks registered in the schedule, tasks with the date and time before the current date and time are used as the achievements. The insurance salesperson can register the achievements by moving and correcting each of the tasks registered in the schedule. Furthermore, each of the tasks registered in the schedule may also be moved and corrected, based on the location information, by the user terminal 11 held by the insurance salesperson. For example, the acquiring unit 53 acquires the location information from the user terminal 11 held by the insurance salesperson. The registration unit 52 may also move and correct, based on the acquired location information, each of the tasks registered in the schedule. For example, the registration unit 52 may also move and correct the move task based on the acquired location information.

Flow of Processes

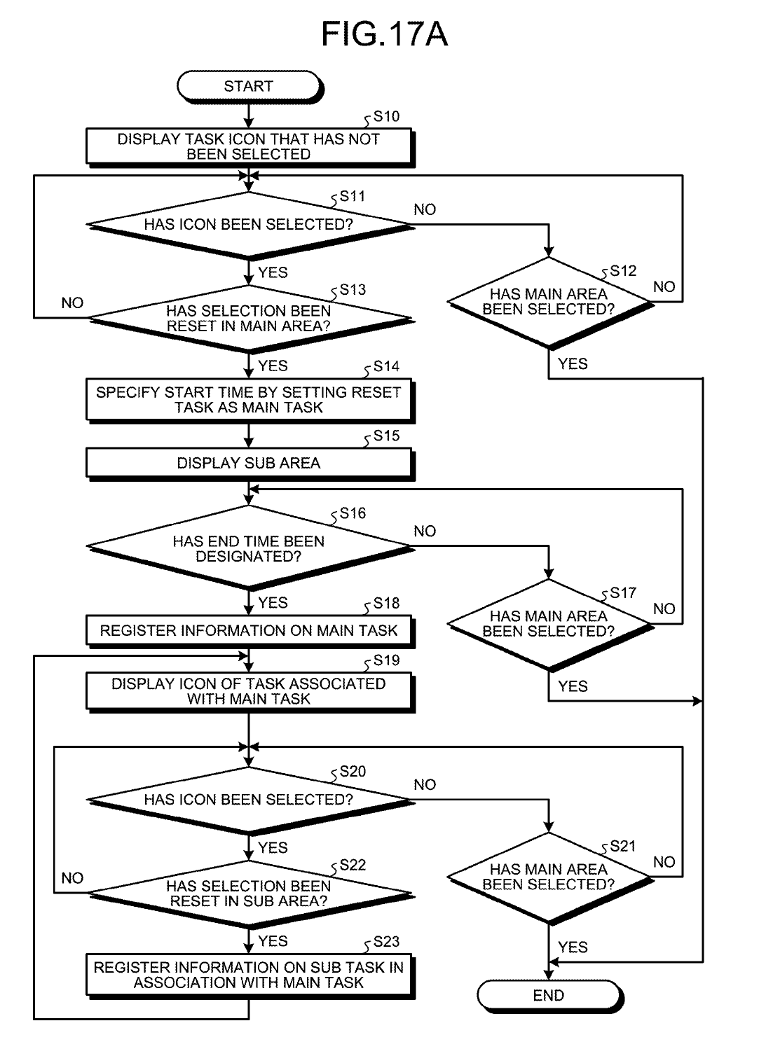

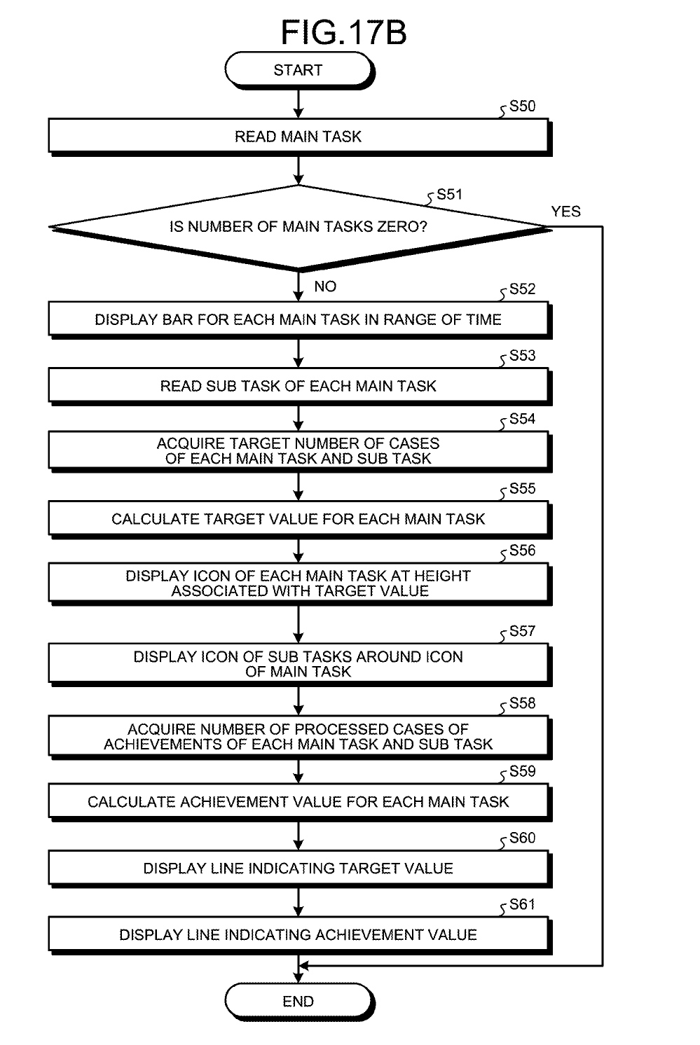

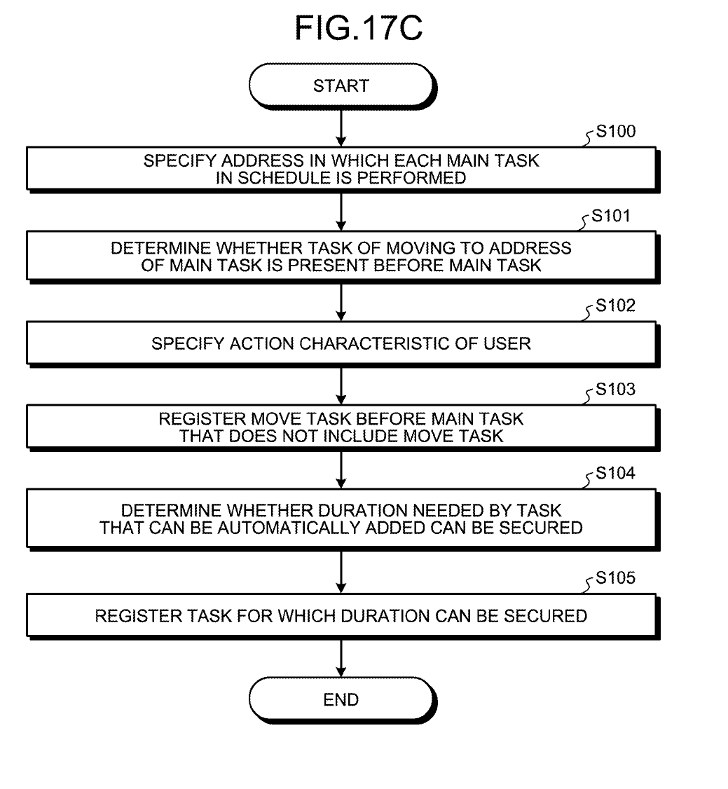

In the following, the flow of various kinds of processes performed by the server device 12 according to the embodiment will be described. First, the flow of a task registration process in which the server device 12 receives the registration of the task with respect to the schedule will be described. FIG. 17A is a flowchart illustrating the flow of the task registration process. The task registration process illustrated in FIG. 17A is performed at a predetermined timing, for example, the timing in which the selection operation of the menu icon 110 on the schedule screen 100 is received.

The display control unit 50 reads, from the menu information 33, the tasks in each of which the item of the selected task is “nil” and displays the icons 120 indicating the read tasks in the order of the “order” around the menu icon 110 (Step S10).

The reception unit 51 determines whether the selection operation of the icon 120 is received (Step S11). If the selection operation of the icon 120 is not received (No at Step S11), the reception unit 51 determines whether the selection operation of the main area 102 is received (Step S12). If the selection operation of the main area 102 is received (Yes at Step S12), the reception unit 51 ends the process.

In contrast, if the selection operation of the main area 102 is not received (No at Step S12), the reception unit 51 proceeds to Step S11 described above.

In contrast, if the selection operation of the main area 102 is not received (Yes at Step S11), the reception unit 51 determines whether the selection of the selected icon 120 has been reset in the main area 102 (Step S13). If the selection of the selected icon 120 has not been reset in the main area 102 (No at Step S13), the reception unit 51 proceeds to Step S11 described above.

In contrast, if the selection of the selected icon 120 has been reset in the main area 102 (Yes at Step S13), the reception unit 51 identifies the task of the icon 120 in which the selection has been reset as the main task and specifies the time associated with the position of the reset selection as the start time of the main task (Step S14).

The display control unit 50 displays the sub area 105 in the lower half of the main area 102 (Step S15). The reception unit 51 determines whether the designation of the end time of the main task is received in the sub area 105 (Step S16). If the designation of the end time is not received (No at Step S16), the reception unit 51 determines whether the selection operation of the main area 102 is received (Step S17). If the selection operation of the main area 102 is received (Yes at Step S17), the reception unit 51 ends the process.

In contrast, if the selection operation of the main area 102 is not received (No at Step S17), the reception unit 51 proceeds to Step S16 described above.

In contrast, if the selection operation of the main area 102 is received (Yes at Step S16), the registration unit 52 attaches the unique task ID to the main task and registers the information related to the main task in the main schedule information 34 and the task information 36 (Step S18).

The display control unit 50 reads, from the menu information 33, the tasks in each of which the item of the selected task is identified as the main task and displays the icons 130 of the read tasks in the order of the “order” around the menu icon 110 (Step S19).

The reception unit 51 determines whether the selection operation of the icon 130 is received (Step S20). If the selection operation of the icon 130 is not received (No at Step S20), the reception unit 51 determines whether the selection operation of the main area 102 is received (Step S21). If the selection operation of the icon 130 is received (Yes at Step S21), the reception unit 51 ends the process.

In contrast, if the selection operation of the icon 130 is not received (No at Step S21), the reception unit 51 proceeds to Step S20 described above.

In contrast, if the selection operation of the icon 130 is received (Yes at Step S20), the reception unit 51 determines whether the selection of the selected icon 130 has been reset in the sub area 105 (Step S22). If the selection of the selected icon 130 has not been reset in the sub area 105 (No at Step S22), the reception unit 51 proceeds to Step S20 described above.

In contrast, if the selection of the selected icon 130 has been reset in the sub area 105 (Yes at Step S22), the registration unit 52 attaches the unique task ID by identifying the task of the icon 130 as the subtask, associates the ID with the task ID of the main task, registers the information related to the subtask in the sub schedule information 35 and the task information 36 (Step S23), and proceeds to Step S19 described above.

In the following, the flow of a display process in which the server device 12 displays the schedule in which tasks are registered. FIG. 17B is a flowchart illustrating the flow of the schedule display process. The display process illustrated in FIG. 17B is performed at a predetermined timing, for example, a timing in which a selection operation of the main area 102 on the schedule screen 100 is received.

The display control unit 50 reads, from the main schedule information 34, the main task in which the start date and time or the end date and time includes the date of the date area 103 (Step S50). The display control unit 50 determines whether the number of read main tasks is zero (Step S51). If the number of read main tasks is zero (Yes at Step S51), the display control unit 50 ends the process.

In contrast, if the number of read main tasks is zero (No at Step S51), the display control unit 50 displays, for each main task, the bars 140 in the range of the time of the main area 102 associated with the start date and time and the end date and time of the main task (Step S52).

The display control unit 50 reads, from the sub schedule information 35, the subtasks accompanied by each of the main tasks (Step S53).

The acquiring unit 53 acquires, from the task information 36, the target number of cases of each of the main tasks and the target number of cases of the subtasks that are associated with each of the main tasks (Step S54). The display control unit 50 applies, for each main task, a predetermined weighting in accordance with the type of tasks, adds the weighting of the target number of cases, and calculates the target value for each of the main tasks (Step S55). The display control unit 50 associates the icon 141 of each of the main tasks with the bar 140 of each of the main tasks and displays the main tasks at the height in accordance with the calculated target value (Step S56). Furthermore, if there are subtasks accompanied by the main task, the display control unit 50 displays the icons 142 of the accompanying subtasks around the icon 141 of the main task (Step S57).

The acquiring unit 53 acquires, from the comparison achievement information 37, the number of processed cases of achievements of the comparison target of each of the main tasks and the number of processed cases of achievements of the comparison target of the subtasks associated with each of the main tasks (Step S58).

The display control unit 50 applies, for each main task, the predetermined weighting in accordance with the type of tasks, adds the weighting of the number of processed cases of the achievements, and calculates the achievement value for each main task (Step S59).

The display control unit 50 displays the line 143 that indicates the target value and that is obtained by connecting the icons 141 of the main tasks in accordance with the height of each of the target values (Step S60). Furthermore, the display control unit 50 displays the line 144 that indicates the past achievements and that is obtained by connecting the past achievements in accordance with the height of each of the calculated achievement values at the position of the same time as that of the icon 141 of the main task (Step S61) and ends the process. Furthermore, as illustrated in FIG. 14A, the display control unit 50 may also display each of the target values and the achievement values for each of the main task. Furthermore, as illustrated in FIG. 14B, the display control unit 50 may also display, for each of the main tasks, the remaining need value needed to reach the target value.

In the following, the flow of an automatic registration process in which the server device 12 automatically registers the schedule of the task will be described. FIG. 17C is a flowchart illustrating the flow of the automatic registration process. The automatic registration process illustrated in FIG. 17C is performed at a predetermined timing, for example, the timing of receiving the selection operation of the simulation icon 113.

Regarding each of the main tasks registered in the schedule, the registration unit 52 specifies, along the time, the address in which the main task is performed (Step S100). It is assumed that, regarding the visit task, the address in which the task is performed is the address of the customer corresponding to the visit destination. It is assumed that the main tasks other than the visit task, the address of the place of work for the insurance salesperson doing the work is set to the address in which the task is performed.

The registration unit 52 determines, regarding each of the main tasks registered in the schedule, whether the task of moving to the address in which the subject main task is performed is present before the subject main task (Step S101).

The registration unit 52 reads, from the main schedule information 34, the past schedule of the insurance salesperson with the logged in user ID and specifies the action characteristic of the insurance salesperson (Step S102).

If there is a main task that does not include the move task, the registration unit 52 registers, in accordance with the action characteristic of the user, the move task of moving to the address in which the subject main task is performed in the schedule before the main task (Step S103).

The registration unit 52 refers to the automatic additional task information 38 and determines whether the duration of time needed by the task that can be automatically added can be secured, for each registered task that can be automatically added, in the allowed time zone and in the time zone other than the time zone associated with the tasks registered in the schedule (Step S104). If the duration of time needed by the task that can be automatically added can be secured, the registration unit 52 registers the task that can be automatically added as the main task in the main schedule information 34 and the task information 36 (Step S105) and ends the process.

Effects

The server device 12 according to the embodiment receives registration of a schedule of one or a plurality of tasks. The server device 12 refers to the storage unit 21 that stores therein the events of morning meeting, lunch, and daily report that are associated with both the time zone that is allowed as the allocation destination and the duration and automatically registers, in the schedule when the duration can be secured in the time zone and in a time zone that is other than the time zone associated with the registered one or the plurality of the tasks, the one or the plurality of the tasks and the events of the morning meeting, the lunch, and the daily report. Consequently, even if reception of the registration of the tasks of the events of the morning meeting, the lunch, and the daily report are omitted, the server device 12 can create a schedule in which the tasks of the events of the morning meeting, the lunch, and the daily report have been registered.

Furthermore, the server device 12 according to the embodiment receives a schedule of a first task including designation of a first location. The server device 12 extracts the first location that is designated about the first task and a second location that is designated about a second task subsequent to the received first task. The server device 12 automatically registers, between the first task and the second task in the schedule, a move event in association with a search result of a path from the extracted first location to the second location. Consequently, even if reception of the registration of the task of the move event is omitted, the server device 12 can create a schedule in which the task of the move event has been registered.

Furthermore, the server device 12 according to the embodiment receives registration of the schedule of the first task including designation of the first location. The server device 12 extracts the first location designated about the first task and extracts a first reference location (for example, the address of the place of work for an insurance salesperson doing a work) in which the schedule stored in the storage unit is started or a second reference location (for example, the address of the place of work for the insurance salesperson doing the work) in which the schedule is ended. The server device 12 automatically registers, in the schedule, the move event in association with the search result of the path from the extracted first reference location to the first location or the path from the first location to the second reference location. Consequently, even if reception of the registration of the task of the move event from the first reference location in which the schedule is started and the move event to the second reference location in which the schedule is ended is omitted, the server device 12 can create a schedule in which the task of the move event has been registered.

Furthermore, when the server device 12 according to the embodiment registers the move event in a schedule between the first task and the second task, the server device 12 controls, in accordance with the action characteristic of a specific user stored about the specific user or in accordance with a set rule, arrangement of the move event such that the move event is arranged closer to the estimated time of the completion of the first task or the move event is arranged closer to the estimated time of the start of the second task. Consequently, the server device 12 can arrange the move event in accordance with the action characteristic of the specific user or the set rule.

Furthermore, the server device 12 according to the embodiment stores therein a predetermined event in association with information that is searched by using, as a search key, the location information that is registered in association with the task previous to the predetermined event or the task subsequent to the predetermined event. Consequently, the server device 12 can store the predetermined event in association with the information that is searched based on the location information registered in association with the previous task or the subsequent task.

Furthermore, the server device 12 according to the embodiment identifies the predetermined event as a lunch event related to lunch and stores therein the predetermined event in association with lunch information that is searched by using, as a search key, the location information that is registered in association with the task previous to the predetermined event or the task subsequent to the predetermined event. Consequently, the server device 12 can store therein the lunch event in association with the lunch information that is searched from the location information that is registered in association with the previous task or the subsequent task.

Furthermore, the lunch information according to the embodiment is the information on an eating place that is searched by using the location information as a search key and that is open within the time of the event related to the lunch registered in the schedule. The server device 12 can store therein the lunch information on the eating place that is open within the time of the lunch event in an associated manner.

Furthermore, when the server device 12 according to the embodiment receives a change in the registered move event, the server device 12 updates the search result of the path and registers the updated search result in association with the changed move event. Consequently, even if the registered move event is changed, the server device 12 can update the path in accordance with the change and register the updated path.

Furthermore, the server device 12 according to the embodiment includes path map information from the move source to the move destination in the search result of the path registered in association with the registered move event. Consequently, regarding the registered move event, the server device 12 can exhibit a path map from the move source to the move destination.

### [b] Second Embodiment

In the above explanation, a description has been given of the embodiment of the device disclosed in the present invention; however, the present invention can be implemented with various kinds of embodiments other than the embodiment described above. Therefore, another embodiment included in the present invention will be described below.

For example, in the embodiment described above, an example has been described of a case of managing the schedule of the insurance salesperson as a user. However, the user is not limited to the insurance salesperson.

Furthermore, in the embodiment described above, an example has been described of a case of displaying the schedule in which the flow of time is exhibited in the lateral direction and the target values of the tasks and the past achievement values are exhibited in the vertical direction. However, the embodiment is not limited to this. For example, it may also possible to display the schedule in which the flow of time is exhibited in the vertical direction and the target values of the tasks and the past achievement values are exhibited in the lateral direction. Furthermore, it may also possible to display the schedule in which one of the target values of the tasks and the past achievement values are exhibited.

Furthermore, in the embodiment described above, an example has been described of a case of using the mark associated with the task in the same color. However, the embodiment is not limited to this. For example, the color of the mark associated with the task may also be changed in accordance with the type of the task. For example, regarding the task related to the customer, such as a customer visit, or the like; regarding the task related to the user, such as a morning meeting, a daily report, or the like; and regarding the task that is automatically added, or the like, the color of the mark associated with the task may also be changed.

Furthermore, in the embodiment described above, an example has been described of a case of automatically registering the tasks of the morning meeting, the lunch, and the daily report that are registered in the automatic additional task information 38. However, the embodiment is not limited to this. For example, a telephone task may also be automatically registered. For example, the information on duration is stored in the storage unit 21 in association with a task of an insertion candidate. For example, regarding the telephone task, the duration of 30 minutes is stored in the storage unit 21. The registration unit 52 specifies, based on the duration, the task that is fit in a spare time zone. The registration unit 52 allocates the specified task to the spare time zone and registers the task. Consequently, the server device 12 can automatically register the specific task in the spare time zone. The duration may also be one of the minimum time taken to perform the task of the insertion candidate, the maximum time taken to perform the task of the insertion candidate, and an integral multiple of a predetermined unit of time. For example, regarding the telephone task, the duration of 10 minutes is stored in the storage unit 21 as the minimum time taken to perform the telephone task. Regarding the spare time zone, the registration unit 52 searches for a spare time corresponding to an integral multiple of time based on 10 minutes as unit time. The registration unit 52 allocates the telephone task to the spare time zone and registers the task. Consequently, the server device 12 can allocate a great number of telephone tasks to the spare time zone and can automatically register a greater number of specific tasks in a spare time.

Furthermore, the components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, each of the processing units of the display control unit 50, the reception unit 51, the registration unit 52, and the acquiring unit 53 may also appropriately be integrated or divided. Furthermore, the display control unit 50, the reception unit 51, the registration unit 52, and the acquiring unit 53 may also be separately performed by a plurality of server devices. Furthermore, all or any part of the display control unit 50, the reception unit 51, the registration unit 52, and the acquiring unit 53 can be implemented by a CPU and by programs analyzed and executed by the CPU or implemented as hardware by wired logic.

Schedule Editing Program

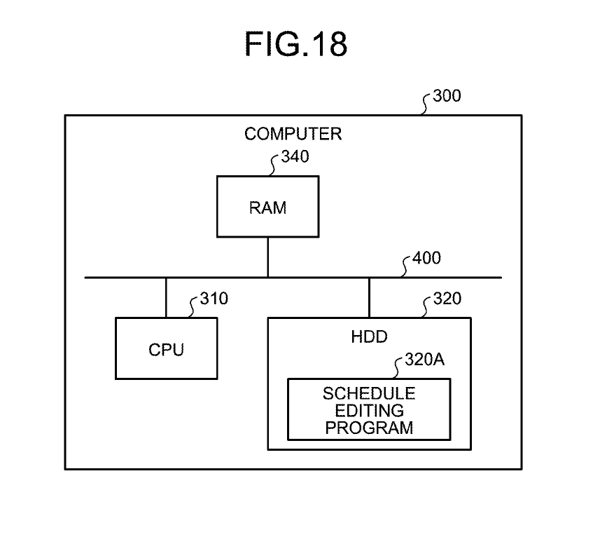

Furthermore, various kinds of processes described in the above embodiments can be implemented by executing programs prepared in advance in a computer system, such as a personal computer, a workstation, or the like. Accordingly, in the following, a description will be given of an example of a computer system that executes a program having the same function as that performed in the embodiments described above. FIG. 18 is a block diagram illustrating a computer that executes a schedule editing program.

As illustrated in FIG. 18, a computer 300 includes a CPU 310, a hard disk drive (HDD) 320, and a random access memory (RAM) 340. Each of the units 310 to 340 are connected via a bus 400.

The HDD 320 stores therein, in advance, a schedule editing program 320A that exhibits the same function as that of each of the processing units in the server device 12 according to the embodiment described above. For example, the schedule editing program 320A that exhibits the same function as that of the display control unit 50, the reception unit 51, the registration unit 52, and the acquiring unit 53 according to the embodiment described above is stored. Furthermore, the schedule editing program 320A may also appropriately be separated.

Furthermore, the HDD 320 stores therein various kinds of data. For example, the HDD 320 stores therein an OS or various kinds of data.

Then, the CPU 310 reads the schedule editing program 320A from the HDD 320 and executes the schedule editing program 320A, whereby the CPU 310 executes the same operation as that executed by each of the display control unit 50, the reception unit 51, the registration unit 52, and the acquiring unit 53 according to the embodiment. Namely, the schedule editing program 320A executes the same operation as that executed by the display control unit 50, the reception unit 51, the registration unit 52, and the acquiring unit 53 according to the embodiment.

Furthermore, the schedule editing program 320A described above does not need to be stored in the HDD 320 from the beginning. For example, the program is stored in a “portable physical medium”, such as a flexible disk (FD), a compact disk read only memory (CD-ROM), a digital versatile disk (DVD disk), a magneto-optic disk, an IC card, or the like, that is to be inserted into the computer 300. Then, the computer 300 may also read and execute the program from the portable physical medium.

Furthermore, the programs may also be stored in “other computers (servers)” or the like connected to the computer 300 via a public circuit, the Internet, a LAN, a WAN, or the like. Then, the computer 300 may also read and execute the program from the other computers

According to an aspect of an embodiment of the present invention, an advantage is provided in that, even if the reception of the registration of a task of a predetermined event is omitted, it is possible to create a schedule in which the task of the predetermined event is registered.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for editing a schedule, the program that causes a computer to execute a process comprising:
receiving registration of a schedule of one or a plurality of tasks; and
referring to a storage unit in which a predetermined event is stored in association with both a time zone that is allowed as allocation destination and duration and registering, in the schedule when the duration can be secured in the time zone and in a time zone other than the time zone associated with the registered one or the plurality of the tasks, the one or the plurality of the tasks and the predetermined event.

2. The non-transitory computer-readable recording medium according to claim 1, wherein the predetermined event is stored in association with information that is searched by using, as a search key, location information that is registered in association with a task previous to the predetermined event or a task subsequent to the predetermined event.

3. The non-transitory computer-readable recording medium according to claim 2, wherein the predetermined event is an event related to lunch and is stored in association with lunch information that is searched by using, as a search key, the location information that is registered in association with the task previous to the predetermined event or the task subsequent to the predetermined event.

4. The non-transitory computer-readable recording medium according to claim 3, wherein the lunch information is information on an eating place that is searched by using the location information as a search key and that is open within the time of the event related to the lunch registered in the schedule.

5. A non-transitory computer-readable recording medium having stored therein a program for editing a schedule, the program that causes a computer to execute a process comprising:
receiving registration of a schedule of a first task including designation of a first location; and
extracting the first location designated about the first task and a second location designated about a second task that is subsequent to the received first task and registering, between the first task and the second task in the schedule, a move event in association with a search result of a path from the extracted first location to the second location.

6. The non-transitory computer-readable recording medium according to claim 5, wherein
the schedule is the schedule related to a specific user, and
the registering includes controlling, when registering the move event in the schedule between the first task and the second task, in accordance with an action characteristic of the specific user stored about the specific user or a set rule, arrangement of the move event such that the move event is arranged closer to the estimated time of the completion of the first task or the move event is arranged closer to the estimated time of the start of the second task.

7. The non-transitory computer-readable recording medium according to claim 5, wherein the registering includes updating, when receiving a change in the registered move event, the search result of the path and registering the updated search result in association with the changed move event.

8. The non-transitory computer-readable recording medium according to claim 5, wherein the search result of the path registered in association with the registered move event includes path map information from a move source to a move destination.

9. A non-transitory computer-readable recording medium having stored therein a program for editing a schedule, the program that causes a computer to execute a process comprising:
receiving registration of a schedule of a first task including designation of a first location; and
extracting the first location designated about the first task and a first reference location in which the schedule stored in a storage unit is started or a second reference location in which the schedule is ended and registering, in the schedule, a move event in association with a search result of a path from the extracted first reference location to the first location or a path from the extracted first location to the second reference location.

10. The non-transitory computer-readable recording medium according to claim 9, wherein the registering includes updating, when receiving a change in the registered move event, the search result of the path and registering the updated search result in association with the changed move event.

11. The non-transitory computer-readable recording medium according to claim 9, wherein the search result of the path registered in association with the registered move event includes path map information from a move source to a move destination.

12. A non-transitory computer-readable recording medium having stored therein a program for editing a schedule related to a specific user, the program that causes a computer to execute a process comprising:
receiving registration of a schedule of one or a plurality of tasks;
referring to, when a spare time zone is present other than a time zone associated with the received one or the plurality of the tasks, a storage unit in which duration is stored in association with a task of an insertion candidate and specifying, based on the duration, a task that is fit in the spare time zone; and
allocating the specified task to the spare time zone.

13. The non-transitory computer-readable recording medium according to claim 12, wherein the stored duration is one of the minimum time taken to perform the task of the insertion candidate, the maximum time taken to perform the task of the insertion candidate, and an integral multiple of a predetermined unit of time.

14. A schedule editing method comprising:
receiving, by a processor, registration of a schedule of one or a plurality of tasks; and
referring, by the processor, to a storage unit in which a predetermined event is stored in association with both a time zone that is allowed as allocation destination and duration and registering, by the processor, in the schedule when the duration can be secured in the time zone and in a time zone other than the time zone associated with the registered one or the plurality of the tasks, the one or the plurality of the tasks and the predetermined event.

15. A schedule editing method comprising:
receiving, by a processor, registration of a schedule of a first task including designation of a first location; and
extracting, by the processor, the first location designated about the first task and a second location designated about a second task that is subsequent to the received first task and registering, by the processor, between the first task and the second task in the schedule, a move event in association with a search result of a path from the extracted first location to the second location.

16. A schedule editing method comprising:
receiving, by a processor, registration of a schedule of a first task including designation of a first location; and
extracting, by the processor, the first location designated about the first task and a first reference location in which the schedule stored in a storage unit is started or a second reference location in which the schedule is ended and registering, by the processor, in the schedule, a move event in association with a search result of a path from the extracted first reference location to the first location or a path from the extracted first location to the second reference location.

17. A schedule editing method comprising:
receiving, by a processor, registration of a schedule of one or a plurality of tasks;
referring to, by the processor, when a spare time zone is present other than a time zone associated with the received one or the plurality of the tasks, a storage unit in which duration is stored in association with a task of an insertion candidate and specifying, based on the duration, a task that is fit in the spare time zone; and
allocating, by the processor, the specified task to the spare time zone.

18. A schedule editing device comprising: a processor that executes a process, the process comprising:
receiving registration of a schedule of one or a plurality of tasks; and
referring to a storage unit in which a predetermined event is stored in association with both a time zone that is allowed as allocation destination and duration and registering, in the schedule when the duration can be secured in the time zone and in a time zone other than the time zone associated with the registered one or the plurality of the tasks, the one or the plurality of the tasks and the predetermined event.

19. A schedule editing device comprising: a processor that executes a process, the process comprising:
receiving registration of a schedule of a first task including destination of a first location; and
extracting the first location designated about the first task and a second location designated about a second task that is subsequent to the received first task and registering, between the first task and the second task in the schedule, a move event in association with a search result of a path from the extracted first location to the second location.

20. A schedule editing device comprising:
a processor that executes a process, the process including:
receiving registration of a schedule of a first task including designation of a first location; and
extracting the first location designated about the first task and a first reference location in which the schedule stored in a storage unit is started or a second reference location in which the schedule is ended and registering, in the schedule, a move event in association with a search result of a path from the extracted first reference location to the first location or a path from the extracted first location to the second reference location.

21. A schedule editing device comprising:
a processor that executes a process, the process including:
receiving registration of a schedule of one or a plurality of tasks;
referring to, when a spare time zone is present other than a time zone associated with the received one or the plurality of the tasks, a storage unit in which duration is stored in association with a task of an insertion candidate and specifying, based on the duration, a task that is fit in the spare time zone; and
allocating the specified task specified by the specifying unit to the spare time zone and that registers the allocated task.
